(19) United States
(12) Patent Application Publication
(10) Pub. No.: US 2021/0022540 A1
(43) Pub. Date: Jan. 28, 2021

(54) POT ASSEMBLY AND COOKING APPLIANCE

(71) Applicant: FOSHAN SHUNDE MIDEA ELECTRICAL HEATING APPLIANCES MANUFACTURING CO., LIMITED, Foshan (CN)

(72) Inventors: Weiming HUANG, Foshan (CN); Huayong LIU, Foshan (CN); Shenghua XING, Foshan (CN); Xin YAO, Foshan (CN); Xiaoying WANG, Foshan (CN); Zhijia LIANG, Foshan (CN); Feilong LUO, Foshan (CN); Ruofei YAN, Foshan (CN); Yuehong QU, Foshan (CN); Xiaoliang YANG, Foshan (CN)

(21) Appl. No.: 17/042,187

(22) PCT Filed: Aug. 30, 2019
(86) PCT No.: PCT/CN2019/103761

§ 371 Date: Sep. 28, 2020

(30) Foreign Application Priority Data
Jan. 29, 2019 (CN) 201910088196.7
Jan. 29, 2019 (CN) 201920156077.6
Aug. 8, 2019 (CN) 201910731209.8

(51) Int. Cl. A47J 27/05

(52) U.S. Cl. CPC A47J 27/05; A47J 2027/043

(57) ABSTRACT

The present disclosure provides a pot assembly and a cooking appliance, the pot assembly comprising an inner pot and a food steamer. The inner pot defines a cooking chamber; the food steamer is placed in the cooking chamber, the food steamer is provided with communication holes communicating with the cooking chamber, the food steamer comprises a bottom wall; the inner pot and/or the food steamer is provided with a draining-steaming-cooked rice waterline, and the draining-steaming-cooked rice waterline is higher than the bottom wall of the food steamer. In the pot assembly provided by the present disclosure, by arranging the draining-steaming-cooked rice waterline to be higher than the bottom wall of the food steamer and determining the amount of a solution and the amount of a material to be cooked according to the information of solution and the information of material to be cooked indicated by the draining-steaming-cooked rice waterline.

### CROSS-REFERENCES TO RELATED APPLICATIONS

The present disclosure is a national phase application of International Application No. PCT/CN2019/103761, filed on Aug. 30, 2019, which claims the priority of Chinese Patent Application No. 2019100881967, filed in the Chinese Patent Office on Jan. 29, 2019, the priority of Chinese Patent Application No. 2019107312098, filed in the Chinese Patent Office on Aug. 8, 2019, and the priority of Chinese Patent Application No. 2019201560776, filed in the Chinese Patent Office on Jan. 29, 2019, the entire contents of which are herein incorporated by reference.

### FIELD

The present disclosure relates to the field of kitchen utensils, and particularly relates to a pot assembly and a cooking appliance comprising the pot assembly.

### BACKGROUND

Draining-steaming-cooked rice (rice cooked by a traditional method of draining half-cooked rice and then steaming the same using a wooden rice steamer), also known as wooden rice steamer-cooked rice, is a tradition in most of China's rural areas for thousands of years. With the advent of electric cookers, this tradition can be said to disappear in most of the rural areas. Because of the complexity of the process, only a few places or restaurants are continuing this practice.

In some methods, a food steamer is disposed in a cooking appliance to make draining-steaming-cooked rice. The process is simple and the cost is low. However, it is not easy to exactly determine the amount of the solution and the amount of the material to be cooked. Moreover, an inexact determination of the amount of the solution and the amount of the material will affect the taste of the material after the completion of the cooking and affect the user experience.

### SUMMARY

The present disclosure aims to solve at least one of the problems existing in the prior art.

To this end, the object of one aspect of the present disclosure is to provide a pot assembly.

The object of the other aspect of the present disclosure is to provide cooking appliance comprising the pot assembly.

In order to achieve the objects, a solution of one aspect of the present disclosure provides a pot assembly, comprising: an inner pot, defining a cooking chamber; and a food steamer, configured to be adapted to be placed in the cooking chamber, the food steamer being provided with communication holes communicating with the cooking chamber, the food steamer comprising a bottom wall; the inner pot and/or the food steamer being provided with a draining-steaming-cooked rice waterline, the food steamer being placed in the cooking chamber, and the draining-steaming-cooked rice waterline being higher than the bottom wall of the food steamer.

In the pot assembly provided by the above-described solution of the present disclosure, the draining-steaming-cooked rice waterline is used for indicating information of material to be cooked and information of solution at the time of making draining-steaming-cooked rice. By arranging the draining-steaming-cooked rice waterline to be higher than the bottom wall of the food steamer and determining the amount of a solution and the amount of a material to be cooked according to the information of solution and the information of material to be cooked indicated by the draining-steaming-cooked rice waterline, a better taste of draining-steaming-cooked rice can be achieved after the completion of the cooking of draining-steaming-cooked rice.

In addition, the pot assembly provided by the above-described solution of the present disclosure further has the following additional features:

In the above-described solution, the food steamer comprises a side wall connected to the bottom wall of the food steamer, an inner side wall of the inner pot, a horizontal plane where the bottom wall of the food steamer lies and a horizontal plane where the draining-steaming-cooked rice waterline lies define a first receiving area, the volume of the first receiving area is V1, and in the first receiving area, the volume of the food steamer is B, then 0<(V1−B)/B≤1.

According to 0<(V1−B)/B≤1, it can be satisfied that the material is completely separated from the solution after the completion of the cooking of draining-steaming-cooked rice, which and can ensure the taste of the food on the bottom wall of the food steamer.

In any of the above-described solutions, the food steamer comprises a side wall connected to the bottom wall of the food steamer; the pot assembly comprises a first measuring tool configured to quantify the volume of a material to be cooked, and the first measuring tool has a quantitative volume V11, an inner side wall of the inner pot, a horizontal plane where the bottom wall of the food steamer lies and a horizontal plane where the draining-steaming-cooked rice waterline lies define a first receiving area, in the first receiving area, the volume of the food steamer is B1, B1≤(V11×n+100) ml, and n is a coefficient of the first measuring tool corresponding to the draining-steaming-cooked rice waterline.

According to B1≤(V11×n+100) ml, it can be satisfied that the material is completely separated from the solution after the completion of the cooking of draining-steaming-cooked rice, which and can ensure the taste of the food on the bottom wall of the food steamer.

In any of the above-described solutions, the pot assembly comprises: a second measuring tool configured to quantify the volume of the material to be cooked, and the second measuring tool has a quantitative volume V12; and an inner side wall of the inner pot, a horizontal plane where the bottom wall of the food steamer lies and a horizontal plane where the draining-steaming-cooked rice waterline lies define a first receiving area, an inner wall surface of the side wall of the inner pot and the bottom wall of the food steamer define a first receiving area with the bottom wall of the food steamer as a lower boundary and the draining-steaming-cooked rice waterline as an upper boundary, the volume of the first receiving area is B2, then B2≤(V12×n+100) ml, and n is a coefficient of the second measuring tool of the material to be cooked corresponding to the draining-steaming-cooked rice waterline.

According to B2≤(V12×n+100) ml, it can be satisfied that the material is completely separated from the solution after the completion of the cooking of draining-steaming-cooked rice, which and can ensure the taste of the food on the bottom wall of the food steamer.

In any of the above-described solutions, the inner pot and/or the food steamer are/is provided with a plurality of top-down draining-steaming-cooked rice waterlines, and the draining-steaming-cooked rice waterlines are all higher than the bottom wall of the food steamer; and/or, the inner pot and/or the food steamer are/is provided with a plurality of sets of draining-steaming-cooked rice waterlines, and each set of draining-steaming-cooked rice waterlines include a plurality of top-down draining-steaming-cooked rice waterlines, the plurality of sets of draining-steaming-cooked rice waterlines correspond to different materials to be cooked, and the plurality of sets of draining-steaming-cooked rice waterlines are provided in a circumferential direction of the inner pot and/or the food steamer.

To provide a plurality of top-down draining-steaming-cooked rice waterlines can meet the user's needs for a variety of cooking volumes. Each of the draining-steaming-cooked rice waterlines is higher than the bottom wall of the food steamer, so that the rice grains of the draining-steaming-cooked rice are separated from the solution after the completion of the cooking of draining-steaming-cooked rice, improving the taste of the draining-steaming-cooked rice.

To provide a plurality of sets of draining-steaming-cooked rice waterlines can meet the needs of different kinds of materials to be cooked, for a different material to be cooked, a corresponding draining-steaming-cooked rice waterline is provided, so that the draining-steaming-cooked rice waterlines are more accurate, and in this way, different materials to be cooked can always achieve a good taste.

In any of the above-described solutions, the draining-steaming-cooked rice waterline satisfies:

0<C/D≤1.4, and C is the weight of the solution in the first receiving area corresponding to the information of solution indicated by the draining-steaming-cooked rice waterline, D is the weight of the material to be cooked corresponding to the information of material to be cooked indicated by the draining-steaming-cooked rice waterline, and the bottom wall of the food steamer is adapted to receive the material to be cooked.

Taking the case where the material to be cooked is rice having an average moisture content of less than 17%, the weight of the rice having an average moisture content of less than 17% corresponding to the information of material to be cooked indicated by the draining-steaming-cooked rice waterline refers to the weight D of the rice having an average moisture content of less than 17% corresponding to the draining-steaming-cooked rice waterline, and at the time of making draining-steaming-cooked rice, the rice having an average moisture content of less than 17% and having a weight of D is placed on the bottom wall of the food steamer.

For example, the draining-steaming-cooked rice waterline h is marked with 3, then 3 measuring tools (the measuring tool is a measuring tool associated with the pot assembly, which is the first measuring tool or the second measuring tool) of material to be cooked need to be added onto the bottom wall of the food steamer, and after the addition of the material to be cooked, a solution is added to the cooking chamber to reach the draining-steaming-cooked rice waterline h. It can be understood that the information of material to be cooked indicated by the draining-steaming-cooked rice waterline can be directly provided in the vicinity of the draining-steaming-cooked rice waterline, for example, the draining-steaming-cooked rice waterline h is marked with 3, 3 is the coefficient of the measuring tool of the material, and the information of material to be cooked can also be written in the instructions attached to the product, or obtained by a user by scanning a code or from the Internet.

In order to meet the need of different cooking volumes, there are a plurality of top-down draining-steaming-cooked rice waterlines, and each draining-steaming-cooked rice waterline meets 0<C/D≤1.4, and C and D are the weight of the solution and the weight of material to be cooked corresponding to a specific draining-steaming-cooked rice waterline, respectively. For example, the draining-steaming-cooked rice waterline h1 is marked with 2, then 2 measuring tools (the measuring tool is a measuring tool associated with the pot assembly, which is the first measuring tool or the second measuring tool) of material to be cooked need to be added onto the bottom wall of the food steamer, and after the addition of the material to be cooked in the first receiving area, a solution is added to the cooking chamber to reach the draining-steaming-cooked rice waterline h1, the amount of the solution and the amount of the material to be cooked are C1 and D1, respectively, then 0<C1/D1≤1.4; and the draining-steaming-cooked rice waterline h2 is marked with 4, then 4 measuring tools (the measuring tool is a measuring tool associated with the pot assembly, which is the first measuring tool or the second measuring tool) of material to be cooked need to be added onto the bottom wall of the food steamer, and after the addition of the material to be cooked in the first receiving area, a solution is added to the cooking chamber to reach the draining-steaming-cooked rice waterline h2, the amount of the solution and the amount of the material to be cooked are C1 and D1, respectively, then 0<C1/D1≤1.4.

C/D>1.4 will lead to incomplete separation between the material on the bottom wall of the food steamer and the solution after the completion of cooking, which will deteriorate the taste of the food on the bottom wall of the food steamer. Therefore, C/D≤1.4 allows complete separation between the material and the solution after the completion of cooking, which can ensure the taste of the food on the bottom wall of the food steamer.

Taking the draining-steaming-cooked rice as an example, the material is rice, the solution is water, C/D>1.4 will lead to incomplete separation between the rice soup and the rice after the completion of the cooking of draining-steaming-cooked rice, which deteriorates the taste of the rice. Therefore, C/D≤1.4 enables complete separation between the rice soup and the food steamer after the completion of the cooking of draining-steaming-cooked rice, and ensuring the taste of the rice. C/D>0, i.e., C>0, and C refers to the weight of the water on the plane where the bottom wall of the food steamer lies in the cooking chamber, between the plane where the draining-steaming-cooked rice waterline lies and the plane where the bottom wall of the food steamer lies, after the rice in the amount D corresponding to the draining-steaming-cooked rice waterline is placed on the food steamer, i.e., the amount of water that should be added for reaching the draining-steaming-cooked rice waterline in the first receiving area, after the rice in the amount D corresponding to the draining-steaming-cooked rice waterline is placed on the bottom wall of the food steamer in the first receiving area.

Rice having an average moisture content of less than 17% may be referred to as unwatered rice or dry rice. The material is rice, the solution is water, and draining-steaming-cooked rice can be made.

In any of the above-described solutions, the draining-steaming-cooked rice waterline is higher than an upper surface of the material to be cooked corresponding to the information of material to be cooked indicated by the draining-steaming-cooked rice waterline, and the bottom wall of the food steamer is adapted to receive the material to be cooked; and/or the volume of the food steamer between the draining-steaming-cooked rice waterline and the bottom wall of the food steamer is greater than the volume of the material to be cooked corresponding to the information of material to be cooked indicated by the draining-steaming-cooked rice waterline, and the bottom wall of the food steamer is adapted to receive the material to be cooked.

The upper surface of the material to be cooked is the upper surface of the material to be cooked after the material to be cooked is completely flattened, so that the material to be cooked is completely immersed in the solution, and ensuring the cooking effect of the upper-layer material to be cooked.

For example, the volume of the food steamer between the draining-steaming-cooked rice waterline and the bottom wall of the food steamer is V, 1 measuring tool of rice (e.g., 150 g rice) corresponds to the volume of approximately 170 ml, then V≥170 ml×E, E is the coefficient of the measuring tool of rice corresponding to the draining-steaming-cooked rice waterline. The volume V between the draining-steaming-cooked rice waterline and the bottom wall of the food steamer is greater than or equal to the volume of the corresponding amount of rice, so V≥170 ml×the coefficient of the measuring tool, for example, the volume V of the draining-steaming-cooked rice waterline corresponding to 1 measuring tool of rice is greater than or equal to 170 ml, the volume V of the draining-steaming-cooked rice waterline corresponding to 2 measuring tools of rice is greater than or equal to 340 ml, and so on, to ensure the cooking effect of the upper-layer rice. In order to improve the cooking effect of the upper-layer rice better, V≥180 ml×the coefficient of the measuring tool.

For the case where the food steamer does not comprise a side wall, “the volume of the food steamer between the draining-steaming-cooked rice waterline and the bottom wall of the food steamer” refers to the volume between the plane where the draining-steaming-cooked rice waterline lies and the bottom wall of the food steamer in the cooking chamber.

In any of the above-described solutions, the food steamer comprises a side wall connected to the bottom wall of the food steamer, a gap between the side wall of the food steamer and the inner side wall of the inner pot is smaller than or equal to 20 mm, and controlling the ratio of (V1−B)/B and C/D, and realizing complete separation between rice soup and rice after the completion of cooking of draining-steaming-cooked rice.

In any of the above-described solutions, the volume of the inner pot between the bottom wall of the food steamer and the bottom wall of the inner pot is V2, then V2≤1000 ml.

When the rice soup of 1 measuring tool of rice is greater than 1000 ml, the rice soup will be relatively clear, with the bottom being easily seen, and have a taste similar to plain boiled water, with no sticky feeling. Therefore, in order to ensure that the rice soup has a certain concentration and the bottom of the pot cannot be seen therethrough, it is necessary to satisfy V2≤1000 ml, to ensure that the concentration of the rice soup obtained by rice-water separation after cooking of rice in a relatively small amount (e.g., 1 measuring tool of rice) is less than 1000 ml, at this time, the bottom of the pot cannot be seen through the rice soup, the rice soup is milky white, and has a certain sticky feeling in mouth, and the measuring tool may be the first measuring tool or the second measuring tool. V2 may be, but is not limited to, 200 ml, 400 ml, 600 ml, 700 ml, 800 ml, or 1000 ml. In order to obtain relatively good taste and a certain amount of rice soup with rice in different amounts, the range of V2 is 400-700 ml.

It should be noted that V2≤1000 ml is applicable to both the case where the food steamer comprises a side wall and the case where the food steamer does not comprise a side wall.

In any of the above-described solutions, the food steamer comprises a side wall connected to the bottom wall of the food steamer, a rounded corner is provided between the side wall of the food steamer and the bottom wall of the food steamer, and the orthographic projection of the rounded corner on the plane where the bottom wall of the food steamer lies has a length of less than or equal to 50 mm; or the food steamer comprises a side wall connected to the bottom wall of the food steamer, and the side wall of the food steamer is connected to the bottom wall of the food steamer by a connecting slope or by a non-arc curve.

In any of the above-described solutions, the food steamer comprises a side wall connected to the bottom wall of the food steamer, the communication holes include first communication holes provided on the side wall of the food steamer, and the area of the first communication hole is smaller than or equal to 20 mm²; and/or the food steamer comprises a side wall connected to the bottom wall of the food steamer, the communication holes include first communication holes provided on the side wall of the food steamer, and the total area of the first communication holes is greater than the minimum flow area of a steam passage of a cooking appliance; and/or the food steamer comprises a side wall connected to the bottom wall of the food steamer, the communication holes include first communication holes provided on the side wall of the food steamer, and the total area of the first communication holes is greater than 10 mm²; and/or the food steamer comprises a side wall connected to the bottom wall of the food steamer, the communication holes include first communication holes provided on the side wall of the food steamer, and the first communication holes are at least partially higher than the highest draining-steaming-cooked rice waterline.

The first communication holes on the side wall of the food steamer communicate the cooking chamber with the first receiving area, and the steam in the cooking chamber is discharged to the outside or enters the first receiving area through the first communication holes. Therefore, the first communication holes serve to discharge steam during the boiling process, and prevent the food steamer from being lifted by steam. The area of the first communication hole is smaller than or equal to 20 mm² to ensure the size of the first communication hole, which, on the one hand, enables the first communication holes to play a role of breaking bubbles to prevent rice soup from overflowing from the cooking appliance, and on the other hand, prevents the first communication holes from greatly reducing the strength of the side wall of the food steamer. It should be noted that the area of the first communication hole being smaller than or equal to 20 mm² means that the area of a single first communication hole is smaller than or equal to 20 mm², and the area of a single first communication hole may be, but is not limited to, 5 mm², 10 mm², 15 mm² or 20 mm².

Taking the case where the first communication hole is a circular hole as an example, the hole diameter of the first communication hole is smaller than or equal to 5 mm, and the hole diameter of the first communication hole may be, but is not limited to, 1 mm, 3 mm, or 5 mm. It will be appreciated that the first communication hole may also be an elongated hole, an elliptical hole, or a hole of any other shapes.

Flow area is the sectional area of a steam passage in the direction perpendicular to the steam flowing direction, and the total area of the first communication holes is greater than the minimum flow area of the steam passage, to ensure that the air pressure outside the food steamer is the same as the air pressure inside the food steamer, as an excessively large pressure outside the food steamer will lift the food steamer. The first communication holes are used to discharge the steam during the boiling process while allowing the rice soup boiling and expanding in the inner pot to flow into the interior of the food steamer. When the total area of the first communication holes is smaller than the minimum flow area of the steam passage, the steam outside the food steamer cannot be discharged in time, then an air pressure is generated, which will lift the food steamer. Even if the bottom wall of the food steamer is provided with communication holes which, for example, also include second communication holes provided on the bottom wall of the food steamer, at this time, the rice will seal the second communication holes, and the steam cannot pass through the rice layer to be discharged. Therefore, the total area of the first communication holes still needs to be larger than the minimum flow area of the steam passage. Taking the case where the section of the steam passage perpendicular to the steam flowing direction is circular as an example, the total area of the first communication holes is larger than the minimum aperture of the steam passage of a cooking appliance. It is to be understood that the section of the steam passage perpendicular to the steam flowing direction may also have any other shapes such as a polygon, an ellipse, or the like.

The first communication hole may have any shape such as a circle, a polygon, an ellipse, or the like. There are a plurality of first communication holes, the plurality of first communication holes are uniformly distributed on the side wall of the food steamer, or are not uniformly distributed, for example, the plurality of first communication holes are distributed in a plurality of regions, each region includes at least one first communication hole, and a plurality of first communication holes are arranged in a centralized manner in each region.

The total area of the first communication holes is greater than 10 mm², ensuring that the rice soup flowing into the food steamer from the second communication holes can smoothly flow back into the cooking chamber through the first communication holes.

There are a plurality of first communication holes, and at least one of the plurality of first communication holes is at least partially higher than the highest draining-steaming-cooked rice waterline. Further, there are a plurality of first communication holes, and at least one of the plurality of first communication holes is at least partially higher than the upper surface of the rice having an average moisture content of less than 17% that corresponds to the maximum draining-steaming-cooked rice waterline, the upper surface referring to the upper surface of the rice after the rice is flattened.

In one embodiment, the number of first communication holes is one, and the first communication hole is at least partially higher than the highest draining-steaming-cooked rice waterline. Further, the first communication hole is at least partially higher than the upper surface of the rice having an average moisture content of less than 17% that corresponds to the maximum draining-steaming-cooked rice waterline.

After an appropriate amount of washed rice is placed in the food steamer, it is ensured that at least one or more first communication holes are higher than the upper surface of the rice having an average moisture content of less than 17%, and that the first communication holes are ventilated smoothly, preventing excessively large side air pressure from lifting the food steamer to cause air leakage of the cooking chamber. Further, after an appropriate amount of washed rice is placed in the food steamer, it is ensured that at least one or some of the first communication holes are higher than the water level, and further improving the smoothness of the steam and the rice soup passing through the first communication holes. Still further, after the cooking is finished, at least one or more first communication holes are kept clear, that is, at least one or more first communication holes are higher than the upper surface of the rice after the cooking is finished, ensuring that the steam is unobstructed.

In any of the above-described solutions, the communication holes include second communication holes provided on the bottom wall of the food steamer, and the diameter of the largest circle capable of flatly passing through the second communication hole is in the range of 0.5 mm-2.5 mm; or the area of the second communication hole is in the range of 0.5 mm²−4 mm²; and/or the communication holes include second communication holes provided on the bottom wall of the food steamer, and the total area of the second communication holes is S1, then S1≥150 mm²; and/or the communication holes include second communication holes provided on the bottom wall of the food steamer, the total area of the second communication holes is S1, and the area of the orthographic projection of the food steamer on a horizontal plane is S2, then S1/S2≥ 1/100.

When the diameter of the largest circle is smaller than 0.5 mm or the area of the second communication hole is smaller than 0.5 mm², the forming of the second communication hole is difficult, which will increase the manufacturing cost of the food steamer; and when the diameter of the largest circle is greater than 2.5 mm or the area of the second communication hole is greater than 4 mm², the rice on the bottom wall of the food steamer will leak through the second communication holes. The diameter of the largest circle may be, but is not limited to, 0.5 mm, 1.0 mm, 1.5 mm, 2.0 mm, or 2.5 mm. Further, in order to facilitate the manufacture of the food steamer by a mold and meet the requirement of the service life of the food steamer, the diameter of the largest circle is 1.8 mm-2.0 mm.

The second communication hole may be a circular hole, a polygonal hole, an elliptical hole or a hole of any other shapes, and the second communication hole shall be sized to allow the boiling rice soup in the inner pot to enter and exit the food steamer through the second communication holes, and also to not allow the rice on the bottom wall of the food steamer to leak through the second communication holes.

In the pot, a large amount of mixture of rice soup and foam is generated, which enters the food steamer and soaks the rice; when heating is not performed at the boiling stage, the mixture of rice, water and foam will flow back through the second communication holes, and S1≥150 mm² can enable the mixture of rice soup and foam in the food steamer to flow back smoothly and rapidly, preventing more rice soup from accumulating in the food steamer due to difficult backflow to cause overflowing.

S2 is the total projection area of the food steamer, which may be an orthographic projection of the food steamer on the bottom wall of the inner pot when placed in the inner pot for use. S1/S2≥ 1/100 further ensures the proportion of the total area of the second communication holes, and ensures that the mixture of rice soup and foam can quickly flow back into the inner pot from the food steamer through the second communication holes, preventing the rice soup and the foam from overflowing from the cooking appliance due to slow backflow of the rice soup and the foam.

In any of the above-described solutions, the upper surface of the bottom wall of the food steamer is provided with a flow guide groove.

The upper surface of the bottom wall of the food steamer is recessed to form a flow guide groove, so the flow guide groove is lower than the bottom wall of the food steamer at the junction with the flow guide groove, so that the flow guide groove can serve the function of flow guiding to guide the flowing of the rice soup and the foam in the food steamer, further preventing the accumulation of the rice soup and the foam in the food steamer. Moreover, the flow guide groove also has the function of enhancing the strength of the bottom of the food steamer.

In any of the above-described solutions, the flow guide groove is provided with flow guide holes penetrating the bottom wall of the food steamer, and the flow guide groove is located at the lowest position of the bottom wall of the food steamer; and/or the communication holes include second communication holes provided on the bottom wall of the food steamer, the bottom wall of the food steamer is provided with a plurality of flow guide grooves, the plurality of flow guide grooves are arranged in a radial shape on the bottom wall of the food steamer, the second communication holes are provided between two adjacent flow guide grooves, or the bottom wall of the food steamer is provided with a plurality of flow guide grooves, the flow guide groove having a ring shape, the plurality of flow guide grooves are arranged in a nested manner insequence, and the second communication holes are provided between two adjacent flow guide grooves.

The rice soup and the foam in the food steamer can flow back into the inner pot through the flow guide holes, and the flow guide holes shall be sized to allow the rice soup and the foam to pass through, and to not allow the rice grains to pass through to prevent the rice in the food steamer from leaking into the inner pot through the flow guide holes. There may be one or more flow guide holes, and the flow guide hole may be a circular hole, a polygonal hole, an elliptical hole, or a hole of any other shapes.

In order to further enhance the flow guiding effect of the flow guide grooves, the flow guide grooves are the lowest part of the bottom wall of the food steamer, so that more rice soup and foam can enter the flow guide grooves and flow back into the inner pot through the flow guide holes.

It is to be understood that the flow guide grooves may have a polygonal shape or any other shapes, and in addition to the radial distribution or the distribution of concentric circles, the flow guide grooves may also be distributed in other shapes, for example, the connection lines of the plurality of flow guide grooves form a polygon, or the plurality of flow guide grooves are irregularly distributed.

In any of the above-described solutions, the food steamer comprises a side wall, the side wall of the food steamer is sleeved on the outer side of the bottom wall of the food steamer and partially below the bottom wall of the food steamer, a portion of the side wall above the bottom wall of the food steamer and the bottom wall of the food steamer define a receiving space, or the food steamer comprises a side wall, the side wall of the food steamer is connected to an edge of the bottom wall of the food steamer and located above the bottom wall of the food steamer; and/or the upper surface or the lower surface of the bottom wall of the food steamer protrudes upwardly or downwardly to form a reinforcing rib.

The side wall of the food steamer is provided with first communication holes. When heating is performed at the boiling stage, after water mixed with starch boils, the mixture of rice soup and foam generated in the pot fills the gap between the food steamer and the inner pot and enters the food steamer from the side wall of the food steamer to completely soak the rice; and when heating is not performed at the boiling stage, the mixture of rice, water and foam flows back to the inner pot through the second communication holes. When the side wall of the food steamer is sleeved on the outer side of the bottom wall of the food steamer, the first communication holes are at least partially provided on the side wall located above the bottom wall of the food steamer.

The side wall of the food steamer and the bottom wall of the food steamer may be a one-piece structure or a split structure.

The reinforcing rib can enhance the strength of the bottom wall of the food steamer and improve the deformation resistance of the food steamer. It is possible that the bottom wall of the food steamer is recessed or protrudes to form a reinforcing rib, for example, the upper surface or the lower surface of the bottom wall of the food steamer is recessed to form a reinforcing rib, and as another example, the upper surface or the lower surface of the bottom wall of the food steamer protrudes upwardly or downwardly to form a reinforcing rib.

There may be one or more reinforcing ribs, and the reinforcing rib may have an elongated shape, a triangular shape, or any other shapes.

In any of the above-described solutions, the food steamer comprises a side wall connected to the bottom wall of the food steamer, the side wall of the food steamer is provided with a first step, the height of the first step from an upper end surface of the food steamer is H1, then 5 mm≤H1≤50 mm; and/or the height of the first step from an upper end surface of the food steamer is H1, the height of the food steamer is H, then 1/9≤H1/H≤¾.

The side wall of the food steamer comprises an upper side wall section, a lower side wall section and the first step, and the upper side wall section, the first step and the lower side wall section are sequentially arranged in a top-down direction. The first step has a ring shape provided in the circumferential direction of the side wall of the food steamer, and the arrangement of the first step can enhance the strength of the side wall of the food steamer.

At least one of the upper side wall section, the lower side wall section and the first step is provided with first communication holes.

When H1 is smaller than 5 mm, the distance between the first step and a flange of the food steamer is too small, which is disadvantageous to the forming of the food steamer, when H1 is greater than 50 mm, the distance between the first step and the bottom wall of the food steamer is too small, rice will contact the first step during cooking, making it not easy to clean the first step after the completion of cooking, and when the first communication holes are provided on the first step, rice will easily leak out of the food steamer from the first communication holes. H1 may be, but is not limited to, 5 mm, 10 mm, 20 mm, 30 mm, 40 mm, or 50 mm. Further, 7 mm≤H1≤20 mm.

1/9≤H1/H≤¾prevents the distance between the first step and the upper end surface of the food steamer from being too large or too small. H1/H may be, but is not limited to, 1/9, ⅓, ½, or ¾. Further, 1/7≤H1/H≤½.

In any of the above-described solutions, the food steamer comprises a side wall connected to the bottom wall of the food steamer, and the height of the food steamer is H, then 40 mm≤H≤100 mm.

H being smaller than 40 mm will affect the volume of the food steamer, and affecting the amount of rice that is allowed for the cooking of draining-steaming-cooked rice. H being greater than 100 mm will lead to a large volume of the inner pot, and leading to a large volume of the cooking appliance. H may be, but is not limited to, 40 mm, 60 mm, 80 mm, or 100 mm. Further, 60 mm≤H≤80 mm.

In any of the above-described solutions, the food steamer comprises a side wall connected to the bottom wall of the food steamer, the side wall of the food steamer is provided with a first flange, the side wall of the inner pot extends outwardly to form a pot rim, the first flange is supported on the pot rim or at a junction between the pot rim and the side wall of the inner pot, and the first flange is lower than the pot rim; and the side wall of the inner pot is connected to the pot rim by a first arc, and the first flange is supported at the first arc; or the pot rim is provided with a second step, and the first flange is supported on the second step; or the side wall of the inner pot is connected to the pot rim by a first slope, and the first flange is supported on the first slope.

An upper end of the side wall of the food steamer is everted to form the first flange, which may be the upper end of the side wall of the food steamer extending outwardly and circumferentially to form a ring-shaped first flange, or the upper end of the side wall of the food steamer extending outwardly to form a plurality of first flanges spaced apart from each other.

The first flange is supported on the inner pot, that is, the food steamer is hung on the inner pot by the first flange, realizing the positioning of the food steamer in the inner pot. The first communication holes may also be provided on the first flange.

A lid body of the cooking appliance covers the pot body, and the cooking appliance comprises a sealing ring, one end of the sealing ring is connected to the lid body, the other end of the sealing ring abuts against the inner pot, further, the other end of the sealing ring abuts against the pot rim, and a closed cooking chamber is formed between the lid body and the inner pot by the sealing ring.

The first flange is lower than the pot rim so that the first flange does not affect sealing between the sealing ring and the inner pot and will not cause air leakage at the sealing ring.

In any of the above-described solutions, the inner pot is provided with a first positioning structure, and the food steamer is positioned with respect to the inner pot by the first positioning structure; and the first positioning structure comprises a third step provided on the side wall of the inner pot, and the bottom wall of the food steamer is supported on the third step; or the first positioning structure comprises a first positioning protrusion provided on the inner side wall of the inner pot, and the bottom wall of the food steamer is supported on the first positioning protrusion; or the first positioning structure comprises a first transition section connected between the side wall of the inner pot and the bottom wall of the inner pot, the cross-sectional area of the first transition section is smaller than the cross-sectional area of the side wall of the inner pot connected to the first transition section, and the food steamer is supported on the first transition section or at a junction between the first transition section and the side wall of the inner pot.

After the food steamer is placed in the inner pot, the food steamer cooperates with the first positioning structure to achieve stable placement of the food steamer in the inner pot.

In any of the above-described solutions, the food steamer is provided with a bracket, and the bracket abuts against the inner pot.

A bracket is provided on the bottom wall of the food steamer, and the bracket abuts against the inner pot, for example, against the bottom wall of the inner pot. In order to improve the stability of the bracket supporting the food steamer, a plurality of brackets are provided, and the plurality of brackets are uniformly disposed in the circumferential direction of the food steamer. The brackets may be fixedly connected or detachably connected to the food steamer.

The arrangement of the structure of the first positioning structure and the brackets is suitable for the food steamer with a side wall and also suitable for the food steamer without a side wall.

It will be appreciated that the brackets may also be connected to the inner pot, and the brackets may be fixedly connected or detachably connected to the inner pot.

In any of the above-described solutions, the draining-steaming-cooked rice waterlines are provided on the inner pot.

For a food steamer without a side wall, the draining-steaming-cooked rice waterlines are provided on the side wall of the inner pot. It is to be understood that it is also feasible to describe the draining-steaming-cooked rice waterlines in the instructions attached to the cooking appliance, for example, describing in the instructions that water covers the surface of rice, in this case, the inner pot and the food steamer may not be provided with draining-steaming-cooked rice waterlines, of course, the inner pot and/or the food steamer may also be provided with draining-steaming-cooked rice waterlines. In one embodiment, a water gauge is sold together with the cooking appliance, the water gauge is provided with draining-steaming-cooked rice waterlines, when cooking, the user places the water gauge in the inner pot, and in this case, the water gauge is used in the same manner as the draining-steaming-cooked rice waterlines printed on the side wall of the inner pot.

In any of the above-described solutions, the food steamer comprises a bottom wall and a side wall connected above the bottom wall, and the draining-steaming-cooked rice waterlines are provided on the side wall of the inner pot and/or on the side wall of the food steamer.

In order to facilitate the user's observation of the draining-steaming-cooked rice waterlines, the draining-steaming-cooked rice waterlines are provided on the side wall of the inner pot or on the side wall of the food steamer.

In any of the above-described solutions, the food steamer is provided with a handle, and the handle is fixedly connected with the food steamer, or the handle is rotatably connected with the food steamer; and/or the pot assembly comprises: a steamer pot, configured to be adapted to be placed in the inner pot and located above the bottom wall of the food steamer; and/or the pot assembly comprises a steaming grid, the steaming grid comprises a bottom wall and a side enclosing wall connected to the bottom wall of the steaming grid, the bottom wall and the side enclosing wall of the steaming grid define a mounting space, the food steamer is located in the mounting space, and the bottom wall and/or the side enclosing wall of the steaming grid are/is provided with third communication holes.

In order to make it convenient to take the food steamer out from the inner pot or place the food steamer in the inner pot, the food steamer is provided with a handle. The user holds the handle to take out or place the food steamer.

For a food steamer without a side wall, the handle is connected to the bottom wall of the food steamer. The bottom wall of the food steamer protrudes upwardly to form a plurality of handles, for example, to form two handles, the two handles being provided at two opposite end portions of the bottom wall of the food steamer. The handle may be solid, or in the form of a handle ring. The handle may cross the food steamer at the middle, one end of the handle is connected to one end portion of the bottom wall of the food steamer, and the other end of the handle is connected to the other end portion of the bottom wall of the food steamer, and in order to reduce the volume of the food steamer, in this case, the handle is rotatably connected to the food steamer.

For a food steamer with a side wall, the handle may be connected to the side wall of the food steamer. The side wall of the food steamer protrudes to form a plurality of handles, and in order not to affect the cooperation between the food steamer and the inner pot, the handles are arranged on the inner wall surface of the side wall of the food steamer and located on the inner side of the side wall of the food steamer, for example, the inner wall surface of the side wall of the food steamer protrudes inwardly to form two handles, and the two handles are provided on two opposite end portions of the side wall of the food steamer. The handle may be solid, or in the form of a handle ring. The handle may cross the food steamer at the middle, one end of the handle is connected to one end portion of the side wall of the food steamer, and the other end of the handle is connected to the other end portion of the side wall of the food steamer, and in order to reduce the volume of the food steamer, in this case, the handle is rotatably connected to the food steamer.

The steamer pot comprises a bottom wall, and the bottom wall of the steamer pot may be provided with through holes penetrating the bottom wall of the steamer pot, or may not be provided with through holes penetrating the bottom wall of the steamer pot. The steamer pot may further comprise a side wall, the side wall of the steamer pot has a ring shape and is connected above the bottom wall of the steamer pot, and the side wall of the steamer pot may be provided with through holes penetrating the side wall of the steamer pot, or may not be provided with through holes penetrating the side wall of the steamer pot. When neither of the bottom wall and the side wall of the steamer pot is provided with through holes, the steamer pot can be used for cooking rice or cooking porridge, and realizing both the cooking of draining-steaming-cooked rice and the cooking of rice or both the cooking of draining-steaming-cooked rice and the cooking of porridge. It will be appreciated that the food steamer is taken out from the inner pot, the steamer pot may be used with the inner pot.

When it is necessary to use the steamer pot, the steamer pot is placed above the food steamer, and when it is not necessary to use the steamer pot, the steamer pot is taken out of the inner pot.

The side enclosing wall of the steaming grid may be sleeved on the outer side of the bottom wall of the steaming grid, and the side enclosing wall is partially located above the bottom wall of the steaming grid and is partially located below the bottom wall of the steaming grid. It is also possible that the side enclosing wall of the steaming grid is wholly located above the bottom wall of the steaming grid.

When the third communication holes meet the requirement of cooking of draining-steaming-cooked rice, that is, the third communication holes can allow steam to enter the mounting space, and can also prevent rice in the mounting space from leaking into the inner pot, draining-steaming-cooked rice can be cooked in the steaming grid, that is, rice used for making draining-steaming-cooked rice is placed on the bottom wall of the steaming grid, and in such a case, the food steamer can be used for other purposes, e.g., making steamed buns and the like.

The size of the third communication hole is not limited, and the use of the steaming grid and the food steamer can be reasonably arranged according to the size of the third communication hole.

In any of the above-described solutions, the pot assembly comprises: a partition configured to be adapted to be placed in the cooking chamber, the partition, and the food steamer jointly partitions the cooking chamber into a plurality of receiving areas, the plurality of receiving areas including the first receiving area and a second receiving area.

The cooking chamber is partitioned into a first receiving area and a second receiving area by the partition and the food steamer. The first receiving area may be used for making draining-steaming-cooked rice, and the user may use the second receiving area according to his own actual needs, for example, cooking rice, cooking porridge, etc. using the second receiving area.

In any of the above-described solutions, the partition, the food steamer, and the inner wall surface of the inner pot jointly define the second receiving area.

The inner wall surface of the inner pot is part of the second receiving area, which can simplify the structure of the partition and reduce the cost of the partition.

In any of the above-described solutions, the food steamer comprises a side wall connected to the bottom wall of the food steamer, and the partition is located outside the food steamer; and/or the partition is located below the bottom wall of the food steamer.

The partition is located outside the food steamer so that the partition does not affect the structure of the food steamer.

The partition is located below the bottom wall of the food steamer, further simplifying the structure of the partition. In this solution, the partition may be in the form of a plate.

In any of the above-described solutions, the partition comprises a bottom wall and a side wall connected to the bottom wall of the partition and located above the bottom wall of the partition, and the food steamer and the partition jointly define the second receiving area.

The partition comprises a bottom wall and a side wall, and the structure of the partition can be reasonably arranged according to the requirements of shape and size of the second receiving area.

In any of the above-described solutions, the side wall of the partition is provided with a second flange, the side wall of the inner pot extends outwardly to form a pot rim, the second flange is supported on the pot rim or at a junction between the pot rim and the side wall of the inner pot, and the second flange is lower than the pot rim; and the side wall of the inner pot is connected to the pot rim by a second arc, and the second flange is supported at the second arc; or the pot rim is provided with a fourth step, and the second flange is supported on the fourth step; or the side wall of the inner pot is connected to the pot rim by a second slope, and the second flange is supported on the second slope.

The second flange is supported on the inner pot, that is, the partition is hung on the inner pot by the second flange, realizing the positioning of the partition in the inner pot.

The second flange is lower than the pot rim, and in this way, the second flange does not affect sealing between the sealing ring and the inner pot and will not cause air leakage at the sealing ring.

In any of the above-described solutions, the inner pot is provided with a second positioning structure, and the partition is positioned with respect to the inner pot by the second positioning structure; and the second positioning structure comprises a fifth step provided on the side wall of the inner pot, and the partition is supported on the fifth step; or the second positioning structure comprises a second positioning protrusion provided on the inner side wall of the inner pot, and the partition is supported on the second positioning protrusion; or the second positioning structure comprises a second transition section connected between the side wall of the inner pot and the bottom wall of the inner pot, the cross-sectional area of the second transition section is smaller than the cross-sectional area of the side wall of the inner pot connected to the second transition section, and the partition is supported on the second transition section or at a junction between the second transition section and the side wall of the inner pot.

After the partition is placed in the inner pot, the partition cooperates with the second positioning structure to achieve stable placement of the partition in the inner pot.

In any of the above-described solutions, the partition is provided with through holes or is not provided with through holes.

The partition may or may not be provided with through holes, depending on the use of the second receiving area and the structure of the partition.

A solution of the second aspect of the present disclosure provides a cooking appliance, comprising: a pot body; and the pot assembly according to any of the solutions of the first aspect, the pot assembly being placed in the pot body.

The cooking appliance provided by the solution of the second aspect of the present disclosure comprises the pot assembly according to any of the solutions of the first aspect, and therefore has all the advantageous effects of the pot assembly according to any of the solutions, which will not be further described here.

The cooking appliance may be an electric cooker, a pressure cooker, or the like.

The cooking appliance may further comprise a lid body, the lid body covering the pot body.

The cooking appliance in the present disclosure can realize the function of cooking draining-steaming-cooked rice, as a food steamer is placed in the inner pot, and can realize normal cooking, e.g., cooking rice or cooking porridge, when the food steamer is taken out of the inner pot.

Additional aspects and advantages of the present disclosure will become apparent in the following description, or are understood by the practice of the present disclosure.

### BRIEF DESCRIPTION OF THE DRAWINGS

The above and/or additional aspects and advantages of the present disclosure will become apparent and readily understood from the following description of embodiments in conjunction with the drawings:

FIG. 1 is a schematic structural view of a pot assembly according to Embodiment I of the present disclosure;

FIG. 2 is a schematic structural view of a food steamer according to Embodiment I of the present disclosure;

FIG. 3 is a schematic sectional view of FIG. 1 in the A-A direction, in which a cooking appliance is in a state before cooking;

FIG. 4 is a schematic sectional view of FIG. 1 in the A-A direction, in which the cooking appliance is in a state after cooking;

FIG. 5 is a schematic sectional view of FIG. 1 in the A-A direction;

FIG. 6 is a schematic sectional view of FIG. 1 in the A-A direction, in which the cooking device is in a heating and boiling state, and the arrow direction indicates the movement direction of steam and rice soup;

FIG. 7 is a schematic sectional view of the cooking appliance according to Embodiment I of the present disclosure;

FIG. 8 is a schematic structural view of the food steamer according to Embodiment I of the present disclosure;

FIG. 9 is a schematic structural view of the food steamer according to Embodiment I of the present disclosure;

FIG. 10 is a schematic structural view of the food steamer according to Embodiment I of the present disclosure, in which the food steamer is not mounted with a handle;

FIG. 11 is a schematic structural view of the food steamer according to Embodiment I of the present disclosure;

FIG. 12 is a schematic partial sectional view of a mating structure of the food steamer and an inner pot according to Embodiment I of the present disclosure;

FIG. 13 is a schematic partial sectional view of the mating structure of the food steamer and the inner pot according to Embodiment I of the present disclosure;

FIG. 14 is a schematic partial sectional view of the mating structure of the food steamer and the inner pot according to Embodiment I of the present disclosure;

FIG. 15 is a schematic structural view of the mating structure of the food steamer and the inner pot according to Embodiment III of the present disclosure;

FIG. 16 is a schematic sectional view of FIG. 15 in the B-B direction, in which the cooking appliance is in a state before cooking;

FIG. 17 is a schematic sectional view of FIG. 15 in the B-B direction, in which the cooking appliance is in a state after cooking;

FIG. 18 is an exploded structural view of the pot assembly according to Embodiment III of the present disclosure;

FIG. 19 is a schematic structural view showing mating between the food steamer and the inner pot according to Embodiment III of the present disclosure;

FIG. 20 is a schematic structural view showing mating between the food steamer and the inner pot according to Embodiment III of the present disclosure;

FIG. 21 is a schematic structural view showing mating between the food steamer and the inner pot according to Embodiment III of the present disclosure;

FIG. 22 is a schematic structural view showing the largest circle passing through a second communication hole according to an embodiment of the present disclosure, in which the entire second communication hole is on a single plane in (a), and the entire second communication hole is not on a single plane in (b);

FIG. 23 is a schematic sectional view of the pot assembly according to Embodiment V of the present disclosure;

FIG. 24 is a schematic sectional view of the pot assembly according to Embodiment VI of the present disclosure;

FIG. 25 is a schematic structural view of the pot assembly according to Embodiment VI of the present disclosure;

FIG. 26 is a schematic sectional view of FIG. 25 in the H-H direction;

FIG. 27 is a schematic sectional view of an assembly structure of the food steamer and the inner pot according to Embodiment I of the present disclosure, in which the cooking appliance is in a state before cooking;

FIG. 28 is a schematic sectional view of the assembly structure of the food steamer and the inner pot according to Embodiment I of the present disclosure, in which the cooking appliance is in a state of being heated at the boiling stage;

FIG. 29 is a schematic sectional view of the assembly structure of the food steamer and the inner pot according to Embodiment I of the present disclosure, in which the cooking appliance is in a state of being not heated at the boiling stage;

FIG. 30 is a schematic sectional view of the assembly structure of the food steamer and the inner pot according to Embodiment III of the present disclosure, in which the cooking appliance is in a state before cooking;

FIG. 31 is a schematic sectional view of the assembly structure of the food steamer and the inner pot according to Embodiment III of the present disclosure, in which the cooking appliance is in a state of being heated at the boiling stage;

FIG. 32 is a schematic sectional view of the assembly structure of the food steamer and the inner pot according to Embodiment III of the present disclosure, in which the cooking appliance is in a state of being not heated at the boiling stage;

FIG. 33 is a schematic structural view of a side wall of the food steamer according to Embodiment VII of the present disclosure;

FIG. 34 is an exploded structural view of the food steamer according to Embodiment VII of the present disclosure, in which the arrow direction indicates the direction in which the bottom wall of the food steamer is put in the side wall of the food steamer; and

FIG. 35 is an exploded structural view of a mating structure of the food steamer and the steaming grid according to Embodiment VIII of the present disclosure, in which the arrow direction indicates the direction in which the food steamer is put in the steaming grid.

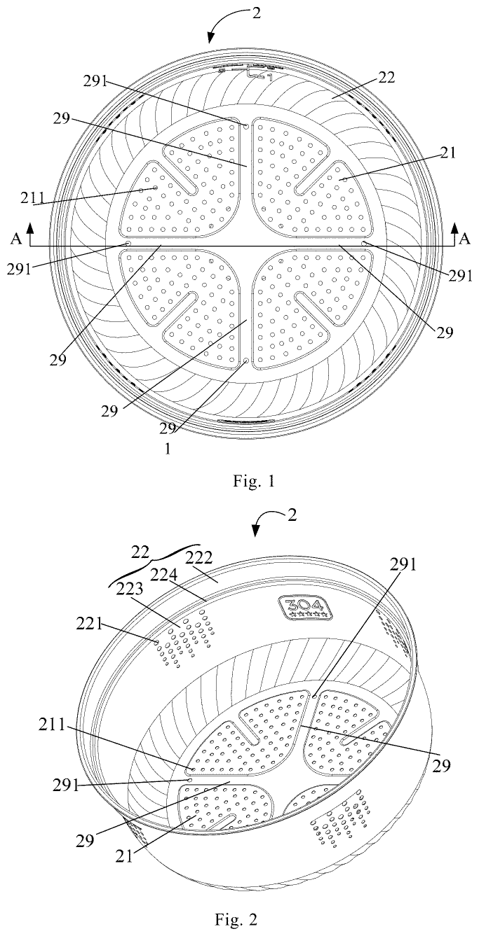

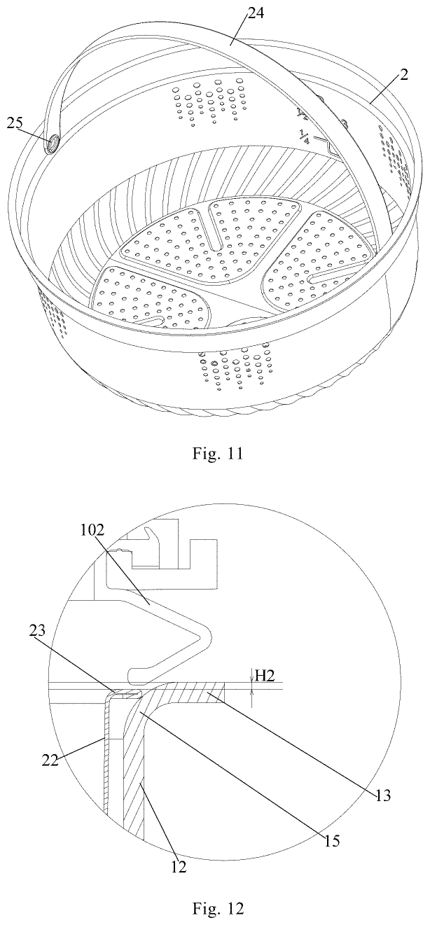

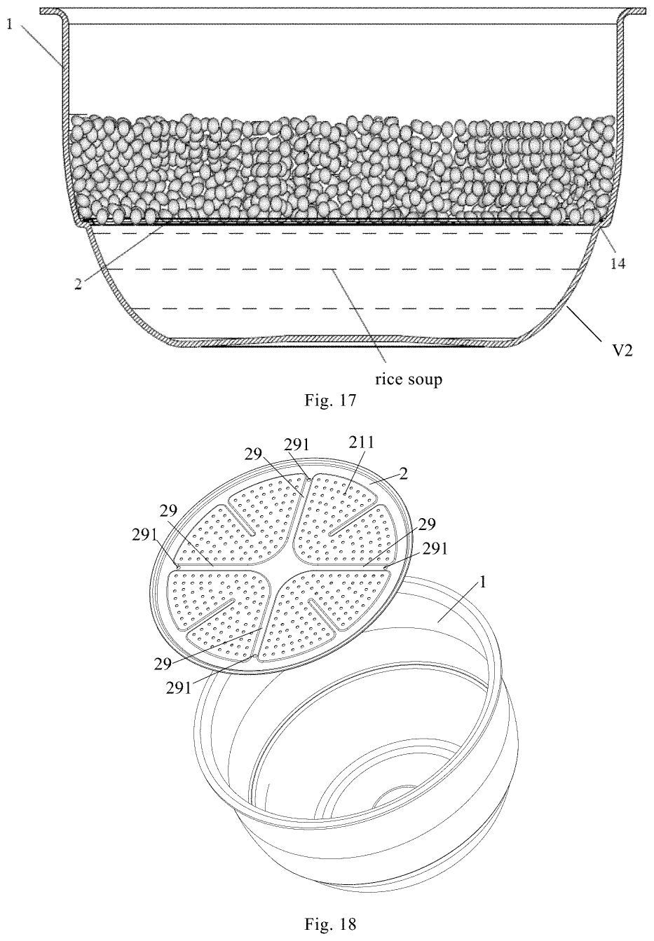

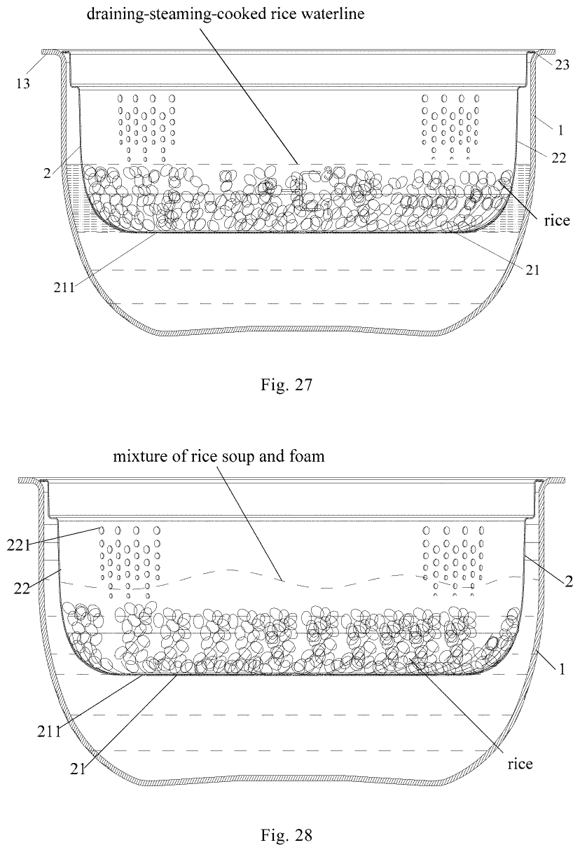

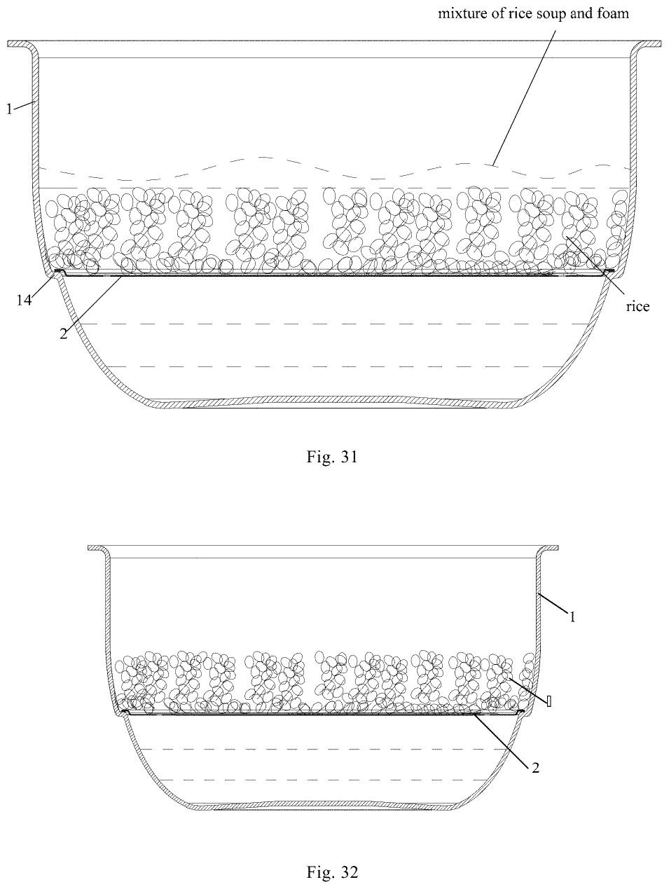

The corresponding relationship between the reference signs and component names in FIG. 1 to FIG. 35 is as follows:

1 inner pot, 11 bottom wall, 12 side wall, 13 pot rim, 14 third step, 15 first arc, 16 second step, 17 first slope, 18 cooking chamber, 19 first transition section, 2 food steamer, 21 bottom wall, 211 second communication hole, 22 side wall, 221 first communication hole, 222 upper side wall section, 223 lower side wall section, 224 first step, 23 first flange, 24 handle, 25 fixing seat, 26 rounded corner, 27 bracket, 28 draining-steaming-cooked rice waterline, 29 flow guide groove, 291 flow guide hole, 3 partition, 31 bottom wall, 32 side wall, 321 second flange, 4 first receiving area, 5 second receiving area, 6 steaming grid, 61 bottom wall, 62 side enclosing wall, 66 third communication hole, 100 cooking appliance, 10 lid body, 101 steam passage, 102 sealing ring, 20 steamer pot, 30 steam, and 40 largest circle.

### DETAILED DESCRIPTION OF THE DISCLOSURE

In order that the above-mentioned objectives, features and advantages of the present disclosure can be understood more clearly, a further detailed description of the present disclosure will be given below in connection with the accompanying drawings and specific embodiments. It should be noted that the embodiments of the present disclosure and the features in the embodiments can be combined with each other if there is no conflict.

In the following description, numerous specific details are set forth in order to provide a thorough understanding of the present disclosure. However, the present disclosure can also be implemented in other manners than those described herein. Therefore, the protection scope of the present disclosure is not limited to the specific embodiments disclosed below.

A pot assembly and a cooking appliance according to some embodiments of the present disclosure are described below with reference to FIG. 1 to FIG. 35.

Draining-steaming-cooked rice, also known as “wooden rice steamer-cooked rice”, is the rice made by a traditional method. In the traditional method, first, rice needs to be cooked in water until it is half-cooked, then the rice is drained, a wet cloth is placed on the bottom of a steaming barrel, the drained rice is placed into the steaming barrel and cooked in a pot, and the rice can be served after the completion of cooking. The rice grains of the resultant draining-steaming-cooked rice are dry and plump, with good taste, and accompanied by sweet and delicious rice soup. Moreover, in the process of rice draining, the solution repeatedly washes the rice grains and removes starch, sugar, etc. from the rice grains. Therefore, the prepared draining-steaming-cooked rice has a low sugar content, and is very suitable for people suffering from diabetes and people who are obese.

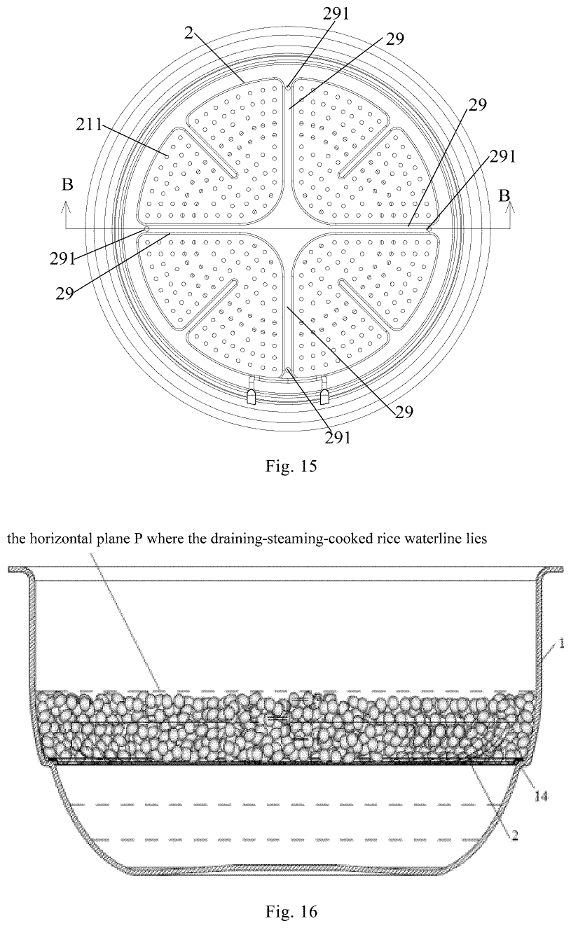

In view of the problem that the traditional cooking method of draining-steaming-cooked rice is complicated and is difficult to implement, the present disclosure provides a pot assembly for a cooking appliance, as shown in FIG. 1 and FIG. 15, the pot assembly provided according to some embodiments of the present disclosure comprising an inner pot 1 and a food steamer 2. The inner pot 1 defines a cooking chamber 18; the food steamer 2 is disposed in the cooking chamber 18, further, the food steamer is disposed in the cooking chamber in such a manner that it can be taken out from and placed into the cooking chamber, the food steamer 2 is provided with communication holes communicating with the cooking chamber 18, and the food steamer 2 comprises a bottom wall 21; as shown in FIG. 9, the inner pot 1 and/or the food steamer 2 are/is provided with a draining-steaming-cooked rice waterline 28 which is higher than the bottom wall 21 of the food steamer 2, when the draining-steaming-cooked rice waterline is provided on the inner pot, the draining-steaming-cooked rice waterline is higher than the bottom wall of the food steamer in a state where the food steamer is placed in the inner pot.

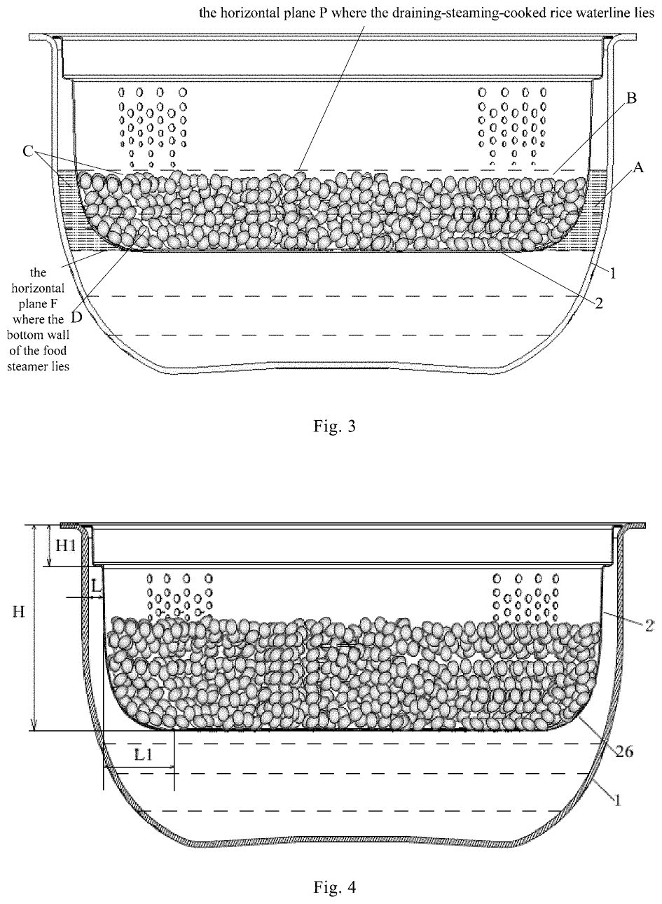

In the case where the bottom wall of the food steamer is planar, as shown in FIG. 3 to FIG. 5, the draining-steaming-cooked rice waterline being higher than the bottom wall of the food steamer means that the draining-steaming-cooked rice waterline is higher than the plane where the bottom wall of the food steamer lies. In the case where the bottom wall of the food steamer is non-planar, the draining-steaming-cooked rice waterline being higher than the bottom wall of the food steamer means that the draining-steaming-cooked rice waterline is higher than the lowest point of the bottom wall of the food steamer, for example, the middle of the upper surface of the bottom wall of the food steamer protrudes upwardly, that is, when the bottom wall of the food steamer is high in the middle and low in the periphery, the draining-steaming-cooked rice waterline is higher than the periphery of the food steamer.

In the pot assembly provided in the above-described embodiment of the present disclosure, the draining-steaming-cooked rice waterline 28 is used for indicating information of material to be cooked and information of solution at the time of making draining-steaming-cooked rice. In the preparation of draining-steaming-cooked rice, a material to be cooked corresponding to the information of material to be cooked indicated by the draining-steaming-cooked rice waterline is placed on the bottom wall of the food steamer, a solution is added into the cooking chamber to reach the draining-steaming-cooked rice waterline, in the working process of the cooking appliance, the heating method of the cooking appliance is controlled to control the solution in the cooking chamber to rise and fall alternately, and the solution in the cooking chamber repeatedly washes and boils the material to be cooked through the communication holes of the food steamer, to wash away sugar and the like from the material to be cooked.

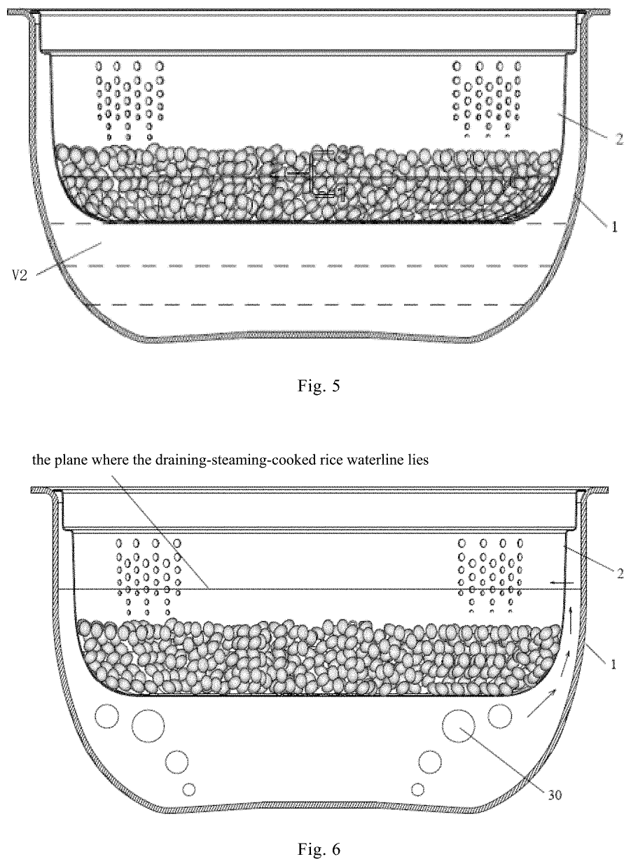

In one embodiment, taking the case where the material to be cooked is rice as an example, the food steamer is hung in the inner pot, rice (corresponding to the information of material to be cooked indicated by the draining-steaming-cooked rice waterline) is washed and then put into the food steamer, at the same time, an appropriate amount of water is put therein according to the draining-steaming-cooked rice waterline 28 of the food steamer, heating is started to make the material and water boil, about 2-10 min later (when the rice is 50%-70% well-cooked), as shown in FIG. 6, heating is stopped, the water level drops due to evaporation and absorption by the rice, and is lower than the bottom wall of the food steamer, at this time, the rice soup is kept slightly boiling, or is kept between 70-99° C., and the rice continues to be steam-cooked for about 10 min, so that the draining-steaming-cooked rice can be obtained. The specific heating method in the boiling process is as follows: after heating to the first-time boiling, intermittently heating and stopping heating, so that the rice soup (water) repeatedly rises and falls to realize washing of rice to prevent the rice from caking and wash away some sugar and starch at the same time, which achieves a unique taste and leads to a low GI value, and also reduces sugar intake of the user and is more healthy.

In the present disclosure, the draining-steaming-cooked rice waterline 28 is higher than the bottom wall 21 of the food steamer 2, and a material to be cooked is placed on the bottom wall 21 of the food steamer 2 and a solution is added to reach the draining-steaming-cooked rice waterline 28, and the amount (which may be weight, volume or the like) of the material to be cooked corresponds to the information of material to be cooked indicated by the draining-steaming-cooked rice waterline, so that a better taste of draining-steaming-cooked rice can be achieved after the completion of the cooking of draining-steaming-cooked rice.

The inner pot 1 and/or the food steamer 2 being provided with the draining-steaming-cooked rice waterline 28 means that the draining-steaming-cooked rice waterline 28 may be provided on the inner pot 1, provided on the inner wall surface of the side wall of the inner pot, that the draining-steaming-cooked rice waterline 28 may also be provided on the food steamer 2, provided on the inner wall surface of the side wall of the food steamer, and that the draining-steaming-cooked rice waterline may also be provided on both the inner pot and the food steamer. The draining-steaming-cooked rice waterlines provided on the inner pot and the food steamer shall all meet the limitations on the draining-steaming-cooked rice waterline in the present disclosure, and the addition standard of the material to be cooked and the solution applies to a single draining-steaming-cooked rice waterline, for example, if the material is added according to the draining-steaming-cooked rice waterline on the inner pot at the height h, the solution shall also be added according to the draining-steaming-cooked rice waterline on the inner pot at the height h.

As for the manner in which the draining-steaming-cooked rice waterline 28 is determined, it may be determined according to the ratio of amount of the material to be cooked to the solution, e.g., according to the weight ratio or the volume ratio of the material to be cooked to the solution.

### Embodiment I

As shown in FIG. 2 and FIG. 3, the food steamer 2 comprises a side wall 22 connected to the bottom wall 21 of the food steamer 2. Further, the side wall 22 of the food steamer 2 is connected above the bottom wall 21 of the food steamer 2. Still further, the side wall 22 has a ring shape to form a side enclosing wall, the ring-shaped side wall 22 is connected to the edge of the bottom wall 21, and the ring-shaped side wall 22 and the bottom wall 21 define a space for receiving the material to be cooked at the time of making draining-steaming-cooked rice.

Further, the inner pot and/or the food steamer are/is provided with a plurality of top-down draining-steaming-cooked rice waterlines, and the draining-steaming-cooked rice waterlines are all higher than the bottom wall of the food steamer, that is, the draining-steaming-cooked rice waterlines are all higher than the lowest point of the bottom wall of the food steamer.

To provide a plurality of top-down draining-steaming-cooked rice waterlines can meet the user's needs for a variety of cooking volumes. Each of the draining-steaming-cooked rice waterlines is higher than the bottom wall of the food steamer, so that the rice grains of the draining-steaming-cooked rice are separated from the solution after the completion of the cooking of draining-steaming-cooked rice, improving the taste of the draining-steaming-cooked rice.

It will be appreciated that there can also be one draining-steaming-cooked rice waterline.

Further, the inner pot and/or the food steamer are/is provided with a plurality of sets of draining-steaming-cooked rice waterlines, and each set of draining-steaming-cooked rice waterlines include a plurality of top-down draining-steaming-cooked rice waterlines, the plurality of sets of draining-steaming-cooked rice waterlines correspond to different materials to be cooked, and the plurality of sets of draining-steaming-cooked rice waterlines are provided in a circumferential direction of the inner pot and/or the food steamer.

To provide a plurality of sets of draining-steaming-cooked rice waterlines can meet the needs of different kinds of materials to be cooked, for example, two sets of draining-steaming-cooked rice waterlines are provided, which correspond to north-east rice and south rice, respectively. For a different material to be cooked, a corresponding draining-steaming-cooked rice waterline is provided, so that the draining-steaming-cooked rice waterlines are more accurate, and in this way, different materials to be cooked can always achieve a good taste.

It will be appreciated that there can also be only one set of draining-steaming-cooked rice waterlines.

Further, the inner side wall of the inner pot (the inner wall surface of the side wall of inner pot), the horizontal plane where the bottom wall of the food steamer lies and the horizontal plane where the draining-steaming-cooked rice waterline lies define a first receiving area 4 having a volume of V1, and in the first receiving area 4, the volume of the food steamer is B, 0<(V1−B)/B≤1, and at the time of making draining-steaming-cooked rice, the material to be cooked is placed in the food steamer, i.e., the space defined by the bottom wall of the food steamer and the side wall of the food steamer.

In the case where the side wall of the food steamer has a ring shape that extends circumferentially along the bottom wall of the food steamer, the volume B of the food steamer is the volume enclosed by the bottom wall of the food steamer and the side wall of the food steamer.

Further, the upper boundary of the first receiving area 4 refers to the plane where the draining-steaming-cooked rice waterline lies, the plane where the draining-steaming-cooked rice waterline lies is a horizontal plane, and the lower boundary refers to the plane where the upper surface of the bottom wall of the food steamer lies, as shown in FIG. 3, the first receiving area 4 refers to a space in the cooking chamber 18 that is enclosed by the plane P where the draining-steaming-cooked rice waterline 28 lies, the horizontal plane F where the bottom wall 21 of the food steamer 2 lies, and the inner wall surface of the side wall of the inner pot. When the entire bottom wall of the food steamer does not lie on a single plane, for example, the bottom wall of the food steamer is stepped, curved, etc., the horizontal plane where the bottom wall of the food steamer lies refers to the horizontal plane where the lowest part of the bottom wall of the food steamer lies.

In the case where the bottom wall of the food steamer is planar, as shown in FIG. 3 to FIG. 5, the first receiving area refers to a space enclosed by the horizontal plane where the draining-steaming-cooked rice waterline lies, the inner side wall of the inner pot, and the horizontal plane where the upper surface of the bottom wall of the food steamer lies, and the volume between the inner side wall of the inner pot and the food steamer is A, then V1=A+B.

(V1−B)/B being greater than 0 means that the volume between the inner wall surface of the side wall of the inner pot and the food steamer is greater than 0, and 0<(V1−B)/B≤1 can achieve complete separation between the material and the solution after the completion of the cooking of draining-steaming-cooked rice, so that the rice grains of the resultant draining-steaming-cooked rice are dry and plump, with good taste, and the draining-steaming-cooked rice has a low sugar content, making it very suitable for people suffering from diabetes and people who are obese, and is also accompanied by sweet and delicious rice soup.

Description is made by taking the case where the material to be cooked or the material is rice and the solution is water as an example. It can be understood that in making draining-steaming-cooked rice, the user can also add other auxiliary materials, such as beans, according to his own preference, in such cases, the material to be cooked or the material includes rice and other auxiliary materials, and in addition to water, the solution can also be selected by the user. For other cooking processes than making draining-steaming-cooked rice, the material to be cooked or the material is not necessarily rice, and the solution is not necessarily water.

When 0<(V1−B)/B≤1 is satisfied, rice in an amount (weight or volume) corresponding to the draining-steaming-cooked rice waterline is placed in the food steamer, water is added to reach the draining-steaming-cooked rice waterline, and after the completion of the cooking of draining-steaming-cooked rice, the water level is lower than the bottom wall of the food steamer, and realizing separation between the rice and the water and improving the taste of the draining-steaming-cooked rice.

Further, (V1−B)/B may be, but is not limited to, 0.2, 0.4, 0.6, 0.8, or 1.

The draining-steaming-cooked rice waterline 28 satisfies:

0<C/D≤1.4, and C is the weight of the solution in the first receiving area 4 corresponding to the information of solution indicated by the draining-steaming-cooked rice waterline 28, and D is the weight of the material to be cooked in the first receiving area 4 corresponding to the information of material to be cooked indicated by the draining-steaming-cooked rice waterline 28.

The weight of the material to be cooked in the first receiving area 4 corresponding to the information of material to be cooked indicated by the draining-steaming-cooked rice waterline 28 refers to the weight D of the material to be cooked corresponding to the draining-steaming-cooked rice waterline 28, and at the time of making draining-steaming-cooked rice, the material to be cooked having a weight of D is placed on the bottom wall 21 of the food steamer 2.

The information of solution indicated by the draining-steaming-cooked rice waterline 28 means that if the height of the draining-steaming-cooked rice waterline 28 is h, in the case where the material to be cooked corresponding to the information of material to be cooked indicated by the draining-steaming-cooked rice waterline having a height of h is placed on the bottom wall of the food steamer, the solution is added into the cooking chamber to reach the height h, and the weight of the solution in the first receiving area 4 corresponding to the information of solution indicated by the draining-steaming-cooked rice waterline 28 refers to the weight C of the solution in the cooking chamber 18 between the draining-steaming-cooked rice waterline 28 and the bottom wall 21 of the food steamer 2, when the solution is added to reach the height h, in the case where the material to be cooked corresponding to the draining-steaming-cooked rice waterline 28 having a height of h is placed on the bottom wall 21 of the food steamer 2.

For example, the draining-steaming-cooked rice waterline h is marked with 3, indicating that the coefficient of the measuring tool is 3, then 3 measuring tools (the measuring tool is a measuring tool associated with the pot assembly, which is the first measuring tool or the second measuring tool) of material to be cooked need to be added onto the bottom wall 21 of the food steamer 2, and after the addition of the material to be cooked, a solution is added to the cooking chamber 18 to reach the draining-steaming-cooked rice waterline h. It can be understood that the information of material to be cooked indicated by the draining-steaming-cooked rice waterline 28 can be directly provided in the vicinity of the draining-steaming-cooked rice waterline 28, for example, the draining-steaming-cooked rice waterline h is marked with 3, 3 is the coefficient of the measuring tool of the material, i.e., taking 3 full-capacity measurements using the measuring tool, and the information of material to be cooked can also be written in the instructions attached to the product, or obtained by a user by scanning a code or from the Internet.

In order to meet the need of different cooking volumes, there are a plurality of top-down draining-steaming-cooked rice waterlines 28, and each draining-steaming-cooked rice waterline 28 meets 0<C/D≤1.4, and C and D are the weight of the solution and the weight of material to be cooked corresponding to a specific draining-steaming-cooked rice waterline 28, respectively. For example, the draining-steaming-cooked rice waterline h1 is marked with 2, then 2 measuring tools (the measuring tool is a measuring tool associated with the pot assembly) of material to be cooked need to be added onto the bottom wall 21 of the food steamer 2, and after the addition of the material to be cooked, a solution is added to the cooking chamber 18 to reach the draining-steaming-cooked rice waterline h1, the amount of the solution and the amount of the material to be cooked are C1 and D1, respectively, then 0<C1/D1≤1.4; and the draining-steaming-cooked rice waterline h2 is marked with 4, then 4 measuring tools (the measuring tool is a measuring tool associated with the pot assembly) of material to be cooked need to be added onto the bottom wall 21 of the food steamer 2, and after the addition of the material to be cooked, a solution is added to the cooking chamber 18 to reach the draining-steaming-cooked rice waterline h2, the amount of the solution and the amount of the material to be cooked are C1 and D1, respectively, then 0<C1/D1≤1.4.

C/D>1.4 will lead to incomplete separation between the material on the bottom wall 21 of the food steamer 2 and the solution after the completion of cooking, which will deteriorate the taste of the food on the bottom wall 21 of the food steamer 2. Therefore, C/D≤1.4 allows complete separation between the material and the solution after the completion of cooking, which can ensure the taste of the food on the bottom wall 21 of the food steamer 2.

Further, D is the weight of rice having an average moisture content of less than 17%, and C is the weight of water.

Rice having an average moisture content of less than 17% may be referred to as unwatered rice or dry rice, such as unwashed rice.

Before cooking, in the state where rice having an average moisture content of less than 17% corresponding to the information of material to be cooked indicated by the draining-steaming-cooked rice waterline (i.e., rice having an average moisture content of less than 17% corresponding to the draining-steaming-cooked rice waterline 28) is placed on the food steamer 2, between the plane D where the draining-steaming-cooked rice waterline 28 lies and the plane F corresponding to the bottom wall 21 of the food steamer 2, the weight of the water on the upper side of the plane where the bottom wall 21 of the food steamer 2 lies is C, and the weight of the rice having an average moisture content of less than 17% corresponding to the draining-steaming-cooked rice waterline 28 is D, then C/D≤1.4.

C/D>1.4 will lead to incomplete separation between the rice soup and the rice after the completion of the cooking of draining-steaming-cooked rice, which deteriorates the taste of the rice. Therefore, C/D≤1.4 enables complete separation between the rice soup and the food steamer 2 after the completion of the cooking of draining-steaming-cooked rice, and ensuring the taste of the rice, and C refers to the weight of the water on the plane where the bottom wall 21 of the food steamer 2 lies in the cooking chamber, between the plane where the draining-steaming-cooked rice waterline 28 lies and the plane corresponding to the bottom wall 21 of the food steamer 2, after the rice having an average moisture content of less than 17% and in an amount corresponding to the draining-steaming-cooked rice waterline 28 is placed on the food steamer 2, including the weight of water in the gaps among the rice grains on the bottom wall of the food steamer.

In the case where the food steamer comprises a side wall and the side wall of the food steamer is connected above the bottom wall of the food steamer, C includes: the weight of the water between the side wall of the food steamer and the side wall of the inner pot and the weight of the water inside the food steamer, between the plane D where the draining-steaming-cooked rice waterline 28 lies and the plane F corresponding to the bottom wall 21 of the food steamer 2, in the state where rice having an average moisture content of less than 17% corresponding to the draining-steaming-cooked rice waterline 28 is placed on the food steamer 2. In this case, the side wall of the food steamer is connected to the bottom wall of the food steamer vertically, obliquely or in other forms. For example, when the side wall of the food steamer is connected to the bottom wall obliquely, C refers to the sum of the weight of the water located directly above and obliquely above the bottom wall of the food steamer inside the food steamer and the weight of the water between the side wall of the food steamer and the side wall of the inner pot, between the plane D where the draining-steaming-cooked rice waterline 28 lies and the plane F corresponding to the bottom wall 21 of the food steamer 2, in the state where rice having an average moisture content of less than 17% corresponding to the draining-steaming-cooked rice waterline 28 is placed on the food steamer 2.

At the time of cooking, rice having an average moisture content of less than 17% corresponding to the draining-steaming-cooked rice waterline is placed on the food steamer, and water is added thereto until the water surface reaches the draining-steaming-cooked rice waterline, then cooking is started.

C/D may be, but is not limited to, 1.0, 1.1, 1.2, 1.3, or 1.4. Further, C/D≤1.1, so that after the completion of cooking of draining-steaming-cooked rice, the rice soup is completely separated from the food steamer, ensuring the effect of the rice.

Further, a different kind of rice has a different water absorption rate and a different moisture content, thus, different draining-steaming-cooked rice waterlines 28 may be provided for different kinds of rice.

Before cooking, between the plane D where the draining-steaming-cooked rice waterline 28 lies and the plane F corresponding to the bottom wall 21 of the food steamer 2, the weight of water between the inner pot and the food steamer is W, the weight of water in the food steamer is C1, then C=W+C1, and the weight of the rice in the food steamer is D (referring to the rice having an average moisture content of less than 17%), satisfying (C1+W)/D≤1.4.

In some embodiments, as shown in FIG. 3, before cooking is started, the plane where the draining-steaming-cooked rice waterline 28 lies is higher than the upper surface of the rice having an average moisture content of less than 17% corresponding to the draining-steaming-cooked rice waterline 28, the upper surface being the upper surface of the rice after the rice is completely flattened, allowing the rice to be completely soaked in the water to ensure the cooking effect of the upper-layer rice, the upper surface of the rice here referring to the upper surface of the rice after the rice is flattened on the food steamer.

In some embodiments, the volume of the food steamer 2 between the plane where the draining-steaming-cooked rice waterline 28 lies and the bottom wall 21 of the food steamer 2 is greater than the volume of the rice having an average moisture content of less than 17% corresponding to the draining-steaming-cooked rice waterline, so that the rice can be completely immersed in water.

For example, the volume of the food steamer between the plane where the draining-steaming-cooked rice waterline lies and the bottom wall of the food steamer is V, 1 measuring tool of rice (e.g., 150 g rice) corresponds to the volume of approximately 170 ml, then V≥170 ml×E, E is the coefficient of the measuring tool of rice corresponding to the draining-steaming-cooked rice waterline 28. The volume V between the plane where the draining-steaming-cooked rice waterline 28 lies and the bottom (the bottom wall 21) of the food steamer 2 is greater than or equal to the volume of the corresponding amount of rice, so V≥170 ml×the coefficient of the measuring tool, for example, the volume V of the draining-steaming-cooked rice waterline 28 corresponding to 1 measuring tool of rice (the coefficient of the measuring tool is 1) is greater than or equal to 170 ml, the volume V of the draining-steaming-cooked rice waterline 28 corresponding to 2 measuring tools of rice (the coefficient of the measuring tool is 1) is greater than or equal to 340 ml, and so on, to ensure the cooking effect of the upper-layer rice. In order to improve the cooking effect of the upper-layer rice better, V≥180 ml×the coefficient of the measuring tool.

Further, the food steamer comprises a side wall connected above the bottom wall of the food steamer, a gap L between the side wall of the food steamer and the inner side wall of the inner pot is smaller than or equal to 20 mm, and controlling the ratio of (V1−B)/B, and realizing complete separation between rice soup and rice after the completion of cooking of draining-steaming-cooked rice.

In some embodiments, as shown in FIG. 5, the volume of the inner pot 1 between the bottom wall 21 of the food steamer 2 and the bottom wall 21 of the inner pot 1 is V2, then V2≤1000 ml.

When the rice soup of 1 measuring tool of rice is greater than 1000 ml, the rice soup will be relatively clear, with the bottom being easily seen, and have a taste similar to plain boiled water, with no sticky feeling. Therefore, in order to ensure that the rice soup has a certain concentration and the bottom of the pot cannot be seen therethrough, it is necessary to satisfy V2≤1000 ml, to ensure that the concentration of the rice soup obtained by rice-water separation after cooking of rice in a relatively small amount (e.g., 1 measuring tool of rice) is less than 1000 ml, at this time, the bottom of the pot cannot be seen through the rice soup, the rice soup is milky white, and has a certain sticky feeling in mouth. V2 may be, but is not limited to, 200 ml, 400 ml, 600 ml, 700 ml, 800 ml, or 1000 ml. In order to obtain relatively good taste and a certain amount of rice soup with rice in different amounts, the range of V2 is 400-700 ml.

It should be noted that V2≤1000 ml is applicable to both the case where the food steamer 2 comprises a side wall 22 and the case where the food steamer 2 does not comprise a side wall 22. Further, V2 refers to the volume of the inner pot between the horizontal plane where the lowest part of the bottom wall of the food steamer lies and the horizontal plane where the lowest part of the bottom wall of the inner pot lies.

In some embodiments, as shown in FIG. 4, there is a rounded corner 26 transition between the side wall 22 of the food steamer 2 and the bottom wall 21 of the food steamer 2, and the orthographic projection of the rounded corner on the plane where the bottom wall 21 of the food steamer 2 lies has a length L1 of less than or equal to 50 mm, to control the ratio of A/B, so that completely separation is realized between the rice soup and rice after the completion of the cooking of draining-steaming-cooked rice. It will be appreciated that the side wall of the food steamer may also be connected to the bottom wall of the food steamer by a non-arc straight line or curve.

In some embodiments, as shown in FIG. 2, the communication holes include first communication holes 221 provided on the side wall 22 of the food steamer 2, and the area of the first communication hole 221 is smaller than or equal to 20 mm².

As shown in FIG. 6, the first communication holes 221 on the side wall 22 of the food steamer 2 communicate the cooking chamber 18 with the interior of the food steamer, and the steam 30 in the cooking chamber 18 is discharged to the outside or enters the food steamer through the first communication holes 221. Therefore, the first communication holes 221 serve to discharge steam 30 during the boiling process, and prevent the food steamer 2 from being lifted by steam 30. The area of the first communication hole 221 is smaller than or equal to 20 mm² to ensure the size of the first communication hole, which, on the one hand, enables the first communication holes 221 to play a role of breaking bubbles to prevent rice soup from overflowing from the cooking appliance 100, and on the other hand, prevents the first communication holes 221 from greatly reducing the strength of the side wall 22 of the food steamer 2.

It should be noted that the area of the first communication hole being smaller than or equal to 20 mm² means that the area of a single first communication hole is smaller than or equal to 20 mm², and the area of a single first communication hole may be, but is not limited to, 5 mm², 10 mm², 15 mm² or 20 mm².

Taking the case where the first communication hole is a circular hole as an example, the hole diameter of the first communication hole is smaller than or equal to 5 mm, and the hole diameter of the first communication hole 221 may be, but is not limited to, 1 mm, 3 mm, or 5 mm. Further, the hole diameter of the first communication hole is in the range of 1.5 mm-2.5 mm. It will be appreciated that the first communication hole may also be an elongated hole, an elliptical hole, or a hole of any other shapes.

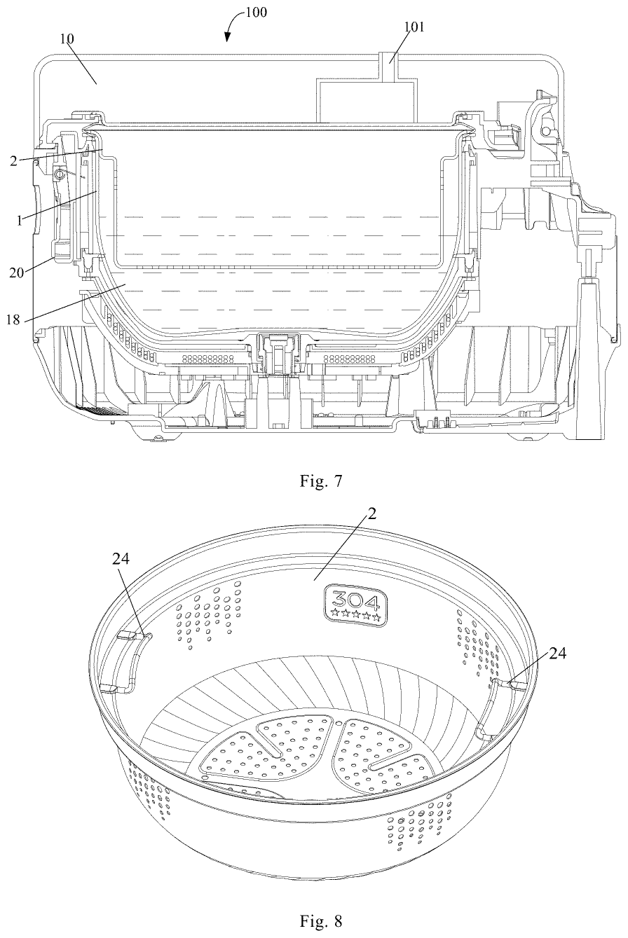

In some embodiments, as shown in FIG. 7, the total area of the first communication holes 221 is greater than the minimum flow area of a steam passage 101 of the cooking appliance 100.

Flow area is the sectional area of a steam passage in the direction perpendicular to the steam flowing direction. The first communication holes 221 are used to discharge the steam 30 during the boiling process while allowing the rice soup boiling and expanding in the inner pot 1 to flow into the interior of the food steamer 2. The total area of the first communication holes 221 is greater than the minimum flow area of the steam passage 101, to ensure that the air pressure outside the food steamer 2 is the same as the air pressure inside the food steamer, preventing an excessively large pressure outside the food steamer 2 from lifting the food steamer 2. When the total area of the first communication holes 221 is smaller than the minimum flow area of the steam passage 101, the steam 30 outside the food steamer 2 cannot be discharged in time, then an air pressure is generated, which will lift the food steamer 2. Even if the bottom wall 21 of the food steamer 2 is provided with second communication holes 211, at this time, the rice will seal the second communication holes 211, and the steam 30 cannot pass through the rice layer to be discharged. Therefore, the total area of the first communication holes 221 still needs to be larger than the minimum flow area of the steam passage 101. Taking the case where the section of the steam passage perpendicular to the steam flowing direction is circular as an example, the total area of the first communication holes is larger than the minimum aperture of the steam passage of a cooking appliance. It is to be understood that the section of the steam passage perpendicular to the steam flowing direction may also have any other shapes such as a polygon, an ellipse, or the like. The cooking appliance comprises a lid body, the lid body covers the pot body, the steam passage is provided on the lid body and is used for communicating the cooking chamber with the outside, and the steam in the cooking chamber is discharged to the outside through the steam passage.

The first communication hole 221 may have any shape such as a circle, a polygon, an ellipse, or the like. There are a plurality of first communication holes 221, the plurality of first communication holes 221 are uniformly distributed on the side wall 22 of the food steamer 2, or are not uniformly distributed, as shown in FIG. 2, for example, the plurality of first communication holes 221 are distributed in a plurality of regions, each region includes at least one first communication hole 221, and a plurality of first communication holes 221 are arranged in a centralized manner in each region.

In some embodiments, the total area of the first communication holes is greater than 10 mm², ensuring that the rice soup flowing into the food steamer from the second communication holes can smoothly flow back into the cooking chamber through the first communication holes.

In a specific embodiment, there are a plurality of first communication holes, and at least one of the plurality of first communication holes is at least partially higher than the highest draining-steaming-cooked rice waterline.

Further, there are a plurality of first communication holes, and at least one of the plurality of first communication holes is at least partially higher than the upper surface of the rice having an average moisture content of less than 17% that corresponds to the maximum draining-steaming-cooked rice waterline, the upper surface referring to the upper surface of the rice after the rice is flattened.

In another specific embodiment, the number of first communication holes is one, and the first communication hole is at least partially higher than the highest draining-steaming-cooked rice waterline. Further, the first communication hole is at least partially higher than the upper surface of the rice having an average moisture content of less than 17% that corresponds to the maximum draining-steaming-cooked rice waterline.

After an appropriate amount of washed rice is placed in the food steamer, it is ensured that at least one or more first communication holes are higher than the upper surface of the rice having an average moisture content of less than 17%, and that the first communication holes are ventilated smoothly, preventing excessively large side air pressure from lifting the food steamer to cause air leakage of the cooking chamber. Further, after an appropriate amount of washed rice is placed in the food steamer, it is ensured that at least one or more first communication holes are higher than the water level, and further improving the smoothness of the steam and the rice soup passing through the first communication holes. Still further, after the cooking is finished, at least one or more first communication holes are kept clear, that is, at least one or some of the first communication holes are higher than the upper surface of the rice after the cooking is finished, ensuring that the steam is unobstructed.

In some embodiments, as shown in FIG. 2 and FIG. 3, the side wall 22 of the food steamer 2 is provided with a first step 224.

The first step 224 has a ring shape provided in the circumferential direction of the side wall 22 of the food steamer 2, and the arrangement of the first step 224 can enhance the strength of the side wall 22 of the food steamer 2. At least one of an upper side wall section 222, a lower side wall section 223 and the first step 224 is provided with the first communication holes 221.

In some embodiments, the height of the first step 224 from an upper end surface of the food steamer 2 is H1, then 5 mm≤H1≤50 mm.

When H1 is smaller than 5 mm, the distance between the first step 224 and a first flange 23 of the food steamer 2 is too small, which is disadvantageous to the forming of the food steamer 2, when H1 is greater than 50 mm, the distance between the first step 224 and the bottom wall 21 of the food steamer 2 is too small, rice will contact the first step 224 during cooking, making it not easy to clean the first step 224 after the completion of cooking, and when the first communication holes 221 are provided on the first step 224, rice will easily leak out of the food steamer 2 from the first communication holes 221. H1 may be, but is not limited to, 5 mm, 10 mm, 20 mm, 30 mm, 40 mm, or 50 mm. Further, 7 mm≤H1≤20 mm.

In some embodiments, as shown in FIG. 4, the height of the first step 224 from an upper end surface of the food steamer 2 is H1, the height of the food steamer 2 is H, then 1/9≤H1/H≤¾.

1/9≤H1/H≤¾prevents the distance between the first step 224 and the upper end surface of the food steamer 2 from being too large or too small. H1/H may be, but is not limited to, 1/9, 1/7, ⅕, ⅓, ½, or ¾. Further, 1/7≤H1/H≤½.

In some embodiments, as shown in FIG. 4, the height of the food steamer 2 is H, then 40 mm≤H≤100 mm.

H being smaller than 40 mm will affect the volume of the food steamer, and affecting the amount of rice that is allowed for the cooking of draining-steaming-cooked rice. H being greater than 100 mm will lead to a large volume of the inner pot 1, and leading to a large volume of the cooking appliance 100. H may be, but is not limited to, 40 mm, 60 mm, 80 mm, or 100 mm. Further, 60 mm≤H≤80 mm.

In some embodiments, as shown in FIG. 12 to FIG. 14, the side wall 22 of the food steamer 2 is provided with a first flange 23, and the first flange 23 is supported on the inner pot 1.

An upper end of the side wall 22 of the food steamer 2 is everted to form the first flange 23, which may be the upper end of the side wall 22 of the food steamer 2 extending outwardly and circumferentially to form a ring-shaped first flange 23, or the upper end of the side wall 22 of the food steamer 2 extending outwardly to form a plurality of first flanges 23 spaced apart from each other.

The first flange 23 is supported on the inner pot 1, that is, the food steamer 2 is hung on the inner pot 1 by the first flange 23, realizing the positioning of the food steamer 2 in the inner pot 1.

In some embodiments, the side wall 22 of the inner pot 1 extends outwardly to form a pot rim 13, the first flange 23 is supported on the pot rim 13 or at a junction between the pot rim 13 and the side wall 12 of the inner pot 1, and the first flange 23 is lower than the pot rim 13, as shown in FIG. 12 to FIG. 14, H2 is greater than 0.

A lid body 10 of the cooking appliance 100 covers the pot body 20, and the cooking appliance 100 comprises a sealing ring 102, one end of the sealing ring 102 is connected to the lid body 10, the other end of the sealing ring 102 abuts against the inner pot 1, further, the other end of the sealing ring 102 abuts against the pot rim 13, and a closed cooking chamber 18 is formed between the lid body 10 and the inner pot 1 by the sealing ring 102.

The first flange 23 is lower than the pot rim 13 so that the first flange 23 does not affect sealing between the sealing ring 102 and the inner pot 1 and will not cause air leakage at the sealing ring 102.

In the first specific embodiment, as shown in FIG. 12, the side wall 12 of the inner pot 1 extends outwardly to form a pot rim 13, the side wall 12 of the inner pot 1 is connected to the pot rim 13 by a first arc 15 or a first non-arc curve, and the first flange 23 is supported at the first arc 15 or at the first non-arc curve.

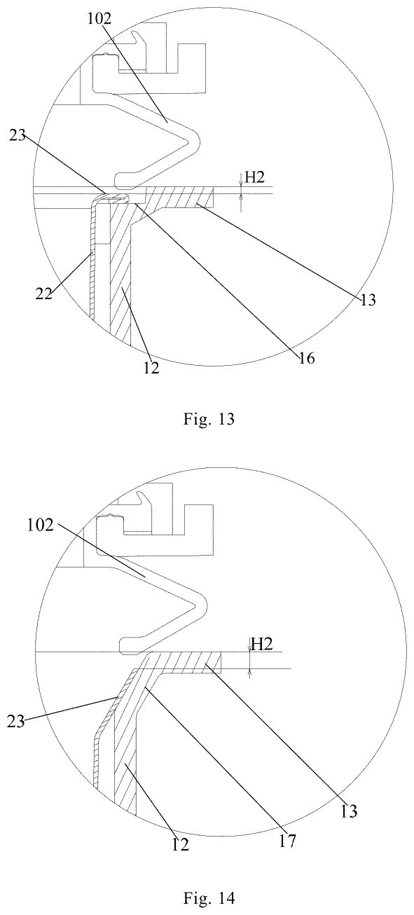

In the second specific embodiment, as shown in FIG. 13, the side wall 12 of the inner pot 1 extends outwardly to form a pot rim 13, the pot rim 13 or the junction between the pot rim 13 and the side wall 12 of the inner pot 1 is recessed to form a second step 16, and the first flange 23 is supported on the second step 16.

In the third specific embodiment, as shown in FIG. 14, the side wall 12 of the inner pot 1 extends outwardly to form a pot rim 13, the side wall 12 of the inner pot 1 is connected to the pot rim 13 by a first slope 17, and the first flange 23 is supported on the first slope 17.

In some embodiments, the draining-steaming-cooked rice waterline 28 is provided on the side wall of the inner pot 1 and/or on the side wall 22 of the food steamer 2.

In order to facilitate the user's observation of the draining-steaming-cooked rice waterline 28, the draining-steaming-cooked rice waterline 28 is provided on the inner wall surface of the side wall 12 of the inner pot 1 or on the inner wall surface of the side wall 22 of the food steamer 2, or the draining-steaming-cooked rice waterline 28 may be provided on both the inner wall surface of the side wall of the inner pot and the inner wall surface of the side wall of the food steamer. It is to be understood that it is also feasible to describe the draining-steaming-cooked rice waterline 28 in the instructions attached to the cooking appliance 100, for example, describing in the instructions that water covers the surface of rice, in this case, the inner pot and the food steamer may not be provided with a draining-steaming-cooked rice waterline, of course, the inner pot and/or the food steamer may also be provided with a draining-steaming-cooked rice waterline. In one embodiment, a water gauge is sold together with the cooking appliance 100, the water gauge is provided with draining-steaming-cooked rice waterline 28, when cooking, the user places the water gauge in the inner pot 1, and in this case, the water gauge is used in the same manner as the draining-steaming-cooked rice waterline 28 printed on the side wall 22 of the inner pot 1.

In some embodiments, as shown in FIG. 22, the communication holes include second communication holes 211 provided on the bottom wall 21 of the food steamer 2, and the diameter of the largest circle 40 capable of flatly passing through the second communication hole 211 is in the range of 0.5 mm-2.5 mm.

“Flatly passing through” is relative to “obliquely passing through”, for example, the second communication hole is in the horizontal plane, “flatly passing through” means that the largest circle is also in the horizontal plane, and the largest circle passes through the second communication hole in the up-down direction.

When the entire second communication hole is in a single plane, as shown in FIG. 22 (C), the largest circle is an inscribed circle of the second communication hole, for example, the second communication hole is a circular hole, then the aperture (diameter) of the second communication hole is in the range of 0.5 mm-2.5 mm, and for example, the second communication hole has an elongated shape, then the width of the second communication hole is in the range of 0.5 mm-2.5 mm. As shown in FIG. 22 (D), when the entire second communication hole is not in a single plane, the second communication hole is orthographically projected on any planes to obtain projection patterns, each projection pattern is inscribed in a circle, and the inscribed circle having the largest diameter is the largest circle.

In some embodiments, the area of the second communication hole 211 is in the range of 0.5 mm²-4 mm².

When the diameter of the largest circle is smaller than 0.5 mm or the area of the second communication hole is smaller than 0.5 mm², the forming of the second communication hole 211 is difficult, which will increase the manufacturing cost of the food steamer 2; and when the diameter of the largest circle is greater than 2.5 mm or the area of the second communication hole is greater than 4 mm², the rice on the bottom wall 21 of the food steamer 2 will leak through the second communication holes 211. The diameter of the largest circle may be, but is not limited to, 0.5 mm, 1.0 mm, 1.5 mm, 2.0 mm, or 2.5 mm, or the area of the second communication hole may be, but is not limited to, 0.5 mm², 1.0 mm², 2.0 mm², 3.0 mm², or 4 mm². Further, in order to facilitate the manufacture of the food steamer 2 by a mold and meet the requirement of the service life of the food steamer 2, the diameter of the largest circle is 1.8 mm-2.0 mm.

The second communication hole 211 may be a circular hole, a polygonal hole, an elliptical hole or a hole of any other shapes, and the second communication hole 211 shall be sized to allow the boiling rice soup in the inner pot 1 to enter and exit the food steamer 2 through the second communication holes 211, and also to not allow the rice on the bottom wall 21 of the food steamer 2 to leak through the second communication holes 211.

The total area of the second communication holes is S1, then S1≥150 mm², which can enable the mixture of rice soup and foam in the food steamer to flow back smoothly and rapidly, preventing more rice soup from accumulating in the food steamer due to difficult backflow to cause overflowing.

Further, the second communication hole 211 penetrates the bottom wall 21 of the food steamer 2 in the thickness direction of the bottom wall 21 of the food steamer 2.

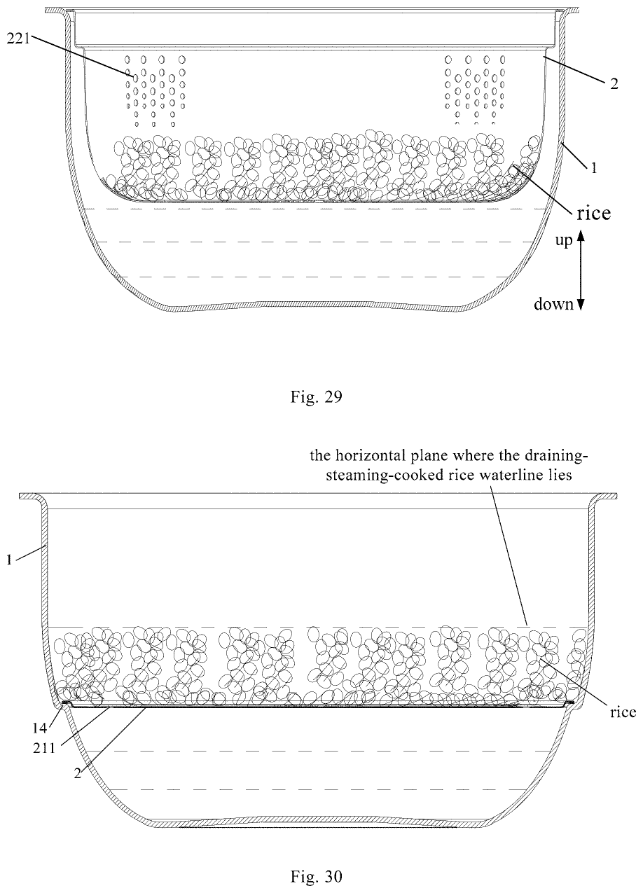

As shown in FIG. 28, in the process of making draining-steaming-cooked rice, when heating is performed at the boiling stage of the cooking appliance, after water mixed with starch boils, a large amount of mixture of rice soup and foam is generated in the pot, which enters the food steamer 2 and soaks the rice; as shown in FIG. 29, when heating is not performed at the boiling stage, the mixture of rice, water and foam will flow back through the second communication holes 211, and S1≥150 mm² can enable the mixture of rice soup and foam in the food steamer 2 to flow back smoothly and rapidly, preventing more rice soup from accumulating in the food steamer 2 due to difficult backflow to cause overflowing.

When there are a plurality of second communication holes, the total area S1 of the second communication holes refers to the sum of the areas of all the second communication holes.

The side wall 22 of the food steamer 2 is provided with first communication holes 221. When heating is performed at the boiling stage, after water mixed with starch boils, the mixture of rice soup and foam generated in the pot fills the gap between the food steamer 2 and the inner pot 1 and enters the food steamer 2 from the first communication holes 221 to completely soak the rice; and when heating is not performed at the boiling stage, the mixture of rice, water and foam flows back to the inner pot 1 through the second communication holes 211.

Further, the area of the orthographic projection of the food steamer 2 on a horizontal plane is S2, then S1/S2≥ 1/100.

S2 is the total projection area of the food steamer 2, which may be an orthographic projection of the food steamer 2 on the bottom wall of the inner pot 1 when placed in the inner pot 1 for use, in other words, the area of the orthographic projection of the food steamer on the plane or the horizontal plane where the bottom wall of the inner pot lies is S2, S1/S2≥ 1/100. S1/S2≥ 1/100 further ensures the proportion of the total area of the second communication holes 211, and ensures that the mixture of rice soup and foam can quickly flow back into the inner pot 1 from the food steamer 2 through the second communication holes 211, preventing the rice soup and the foam from overflowing from the cooking appliance due to slow backflow of the rice soup and the foam.

The food steamer 2 is placed on the inner pot 1, and the side wall 22 of the food steamer 2 is provided with the first communication holes 221. When heating is performed at the boiling stage, after water mixed with starch boils, a large amount of mixture of rice soup and foam is generated in the pot, which fills the gap between the food steamer 2 and the inner pot 1 and enters the food steamer 2 from the side wall 22 of the food steamer 2 to completely soak the rice, as shown in FIG. 28; and when heating is not performed at the boiling stage, the mixture of rice, water and foam flows back to the inner pot 1 through the second communication holes 211 of the bottom wall of the food steamer 2. In order to allow the mixture of rice, water and foam entering the food steamer 2 through the first communication holes 211 to flow back smoothly and quickly, and prevent more rice and water from accumulating in the food steamer 2 due to difficult backflow, which will easily overflow after repeated flushing, the total area S1 of the first communication holes 25: the total projection area S2 of the food steamer 2≥ 1/100, and S1≥150 mm².

In some embodiments, the bottom wall 21 of the food steamer 2 is provided with a reinforcing rib.

The reinforcing rib can enhance the strength of the bottom wall 21 of the food steamer 2 and improve the deformation resistance of the food steamer 2. It is possible that the bottom wall 21 of the food steamer 2 is recessed or protrudes to form a reinforcing rib, for example, the upper surface or the lower surface of the bottom wall 21 of the food steamer 2 is recessed to form a reinforcing rib, and as another example, the upper surface or the lower surface of the bottom wall 21 of the food steamer 2 protrudes upwardly or downwardly to form a reinforcing rib.

There may be one or more reinforcing ribs, and the reinforcing rib may have an elongated shape, a triangular shape, or any other shapes.

In some embodiments, as shown in FIG. 1 and FIG. 2, the upper surface of the bottom wall 21 of the food steamer 2 is provided with a flow guide groove 29.

The upper surface of the bottom wall 21 of the food steamer 2 is recessed to form a flow guide groove 29, so the flow guide groove 29 is lower than the bottom wall 21 of the food steamer 2 at the junction with the flow guide groove 29, so that the flow guide groove 29 can serve the function of flow guiding to guide the flowing of the rice soup and the foam in the food steamer 2, further preventing the accumulation of the rice soup and the foam in the food steamer 2. Moreover, the flow guide groove 29 also has the function of enhancing the strength of the bottom of the food steamer 2.

Further, the flow guide groove 29 is provided with flow guide holes 291, and the flow guide holes 291 penetrate the bottom wall 21 of the food steamer 2 in the thickness direction of the bottom wall 21 of the food steamer 2.

The rice soup and the foam in the food steamer 2 can flow back into the inner pot 1 through the flow guide holes 291, and the flow guide holes 291 shall be sized to allow the rice soup and the foam to pass through, and to not allow the rice grains to pass through to prevent the rice in the food steamer 2 from leaking into the inner pot 1 through the flow guide holes 291. There may be one or more flow guide holes 291, and the flow guide hole 291 may be a circular hole, a polygonal hole, an elliptical hole, or a hole of any other shapes.

In some embodiments, the flow guide groove 29 is located at the lowest position of the bottom wall 21 of the food steamer 2.

In order to further enhance the flow guiding effect of the flow guide grooves 29, the flow guide grooves 29 are the lowest part of the bottom wall 21 of the food steamer 2, so that more rice soup and foam can enter the flow guide grooves 29 and flow back into the inner pot 1 through the flow guide holes 291.

In a specific embodiment, as shown in FIG. 1 and FIG. 2, the bottom wall 21 of the food steamer 2 is provided with a plurality of flow guide grooves 29, the plurality of flow guide grooves 29 are arranged in a radial shape on the bottom wall 21 of the food steamer 2, the second communication holes 211 are provided between two adjacent flow guide grooves 29.

In another specific embodiment, the bottom wall 21 of the food steamer 2 is provided with a plurality of flow guide grooves 29, the flow guide groove 29 having a ring shape, the plurality of flow guide grooves 29 are arranged in a nested manner in sequence, and the second communication holes 211 are provided between two adjacent flow guide grooves 29, for example, the plurality of flow guide grooves 29 are arranged in concentric circles, and further, the center of the concentric circles where the plurality of flow guide grooves 29 lie coincides with the center of the circle where the bottom wall 21 of the food steamer 2 lies.

It is to be understood that the flow guide grooves 29 may have a polygonal shape or any other shapes, and in addition to the radial distribution or the distribution of concentric circles, the flow guide grooves 29 may also be distributed in other shapes, for example, the connection lines of the plurality of flow guide grooves 29 form a polygon, or the plurality of flow guide grooves 29 are irregularly distributed. One flow guide groove 29 is provided with at least one flow guide hole 291.

In some embodiments, as shown in FIG. 8 to FIG. 11, the food steamer 2 is provided with a handle 24.

In order to make it convenient to take the food steamer 2 out from the inner pot 1 or place the food steamer 2 in the inner pot 1, the food steamer 2 is provided with a handle 24. The user holds the handle 24 to take out or place the food steamer 2.

The handle 24 is fixedly connected with the food steamer 2. The handle 24 is rotatably connected with the food steamer 2. In order to facilitate the connection between the handle and the food steamer, a fixing seat 25 is provided on the food steamer, the fixing seat is fixed on the food steamer, and the handle is rotatably connected with the fixing seat.

Example 1: For a food steamer 2 with a side wall 22, the handle 24 may be connected to the side wall 22 of the food steamer 2. The side wall 22 of the food steamer 2 protrudes to form a plurality of handles 24, and in order not to affect the cooperation between the food steamer 2 and the inner pot 1, the handles 24 are arranged on the inner wall surface of the side wall 22 of the food steamer 2 and located on the inner side of the side wall 22 of the food steamer 2, for example, the inner wall surface of the side wall 22 of the food steamer 2 protrudes inwardly to form two handles 24, and the two handles 24 are provided on two opposite end portions of the side wall 22 of the food steamer 2. As shown in FIG. 9, the handle 24 may be solid, or as shown in FIG. 8, the handle 24 may be in the form of a handle ring. In this case, the handle is fixedly or rotatably connected to the food steamer.

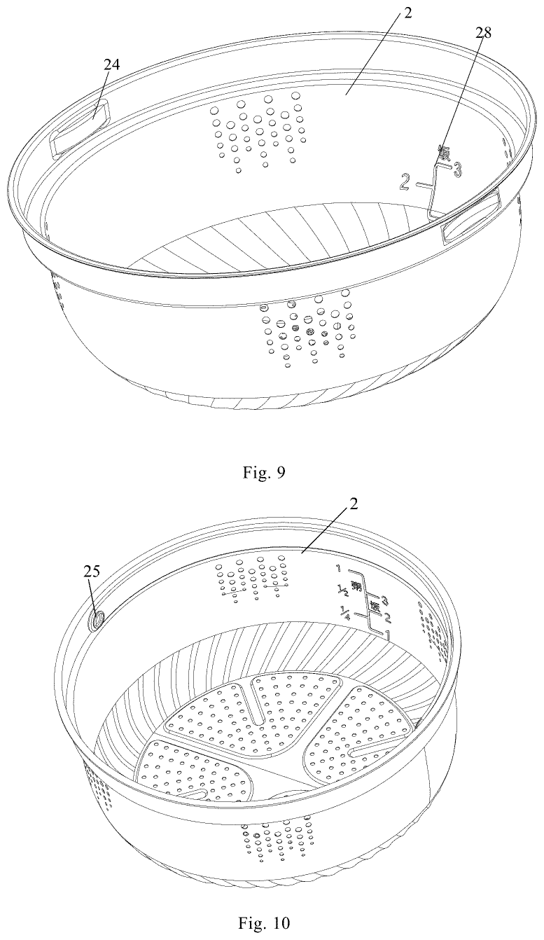

Example 2: The handle 24 may cross the food steamer 2 at the middle, one end of the handle 24 is connected to one end portion of the side wall 22 of the food steamer 2, and the other end of the handle 24 is connected to the other end portion of the side wall 22 of the food steamer 2, and in order to reduce the volume of the food steamer 2, in this case, the handle 24 is rotatably connected to the food steamer 2, as shown in FIG. 10, the other end of the handle is rotatably connected to one end portion of the side wall 22 of the food steamer 2 by the fixing seat 25, and the other end of the food steamer is rotatably connected to the other end portion of the side wall 22 of the food steamer 2 by the fixing seat 25.

### Embodiment II

Embodiment II differs from Embodiment I in that: the pot assembly comprises a first measuring tool configured to quantify the volume of a material to be cooked, and the first measuring tool has a quantitative volume V11, an inner side wall of the inner pot, a horizontal plane where the bottom wall of the food steamer lies and a horizontal plane where the draining-steaming-cooked rice waterline lies define a first receiving area 4, the horizontal plane where the bottom wall of the food steamer lies refers to the horizontal plane where the lowest part of the upper surface of the bottom wall of the food steamer lies, in the first receiving area 4, the volume of the food steamer is B1, B1≤(V11×n+100) ml, and n is a coefficient of the first measuring tool of the material to be cooked corresponding to the draining-steaming-cooked rice waterline.

According to B1≤(V11×n+100) ml, it can be satisfied that the material is completely separated from the solution after the completion of the cooking of draining-steaming-cooked rice, which and can ensure the taste of the food on the bottom wall of the food steamer, and the case can be avoided where, if B1>(V11×n+100) ml, the rice on the bottom wall of the food steamer is not completely separated from the water in the cooking chamber after the completion of the cooking of draining-steaming-cooked rice, so that the taste of the draining-steaming-cooked rice is affected.

That n is a coefficient of the first measuring tool of the material to be cooked corresponding to the draining-steaming-cooked rice waterline means that the material to be cooked needs to be contained inn first measuring tools, for example, the draining-steaming-cooked rice waterline h is marked with 3, then n=3, and 3 first measuring tools (the first measuring tool is the first measuring tool associated with the pot assembly) of material need to be added onto the bottom wall 21 of the food steamer 2, i.e., taking 3 full-capacity measurements using the first measuring tool, and after the addition of rice, water is added to the cooking chamber 18 to reach the draining-steaming-cooked rice waterline h. In another example, the draining-steaming-cooked rice waterline h is marked with 0.5, then n=0.5, and ½ first measuring tool of material needs to be added onto the bottom wall of the food steamer. Thus, n is greater than 0, and may be an integer or a fraction.

It can be understood that the coefficient of the first measuring tool of the material to be cooked corresponding to the draining-steaming-cooked rice waterline can be directly provided in the vicinity of the waterline 28, for example, the draining-steaming-cooked rice waterline h is marked with 3, 3 is the coefficient of the first measuring tool of the material to be cooked, and the coefficient of the first measuring tool of the material to be cooked can also be written in the instructions attached to the product, or obtained by a user by scanning a code or from the Internet.

The first measuring tool is provided with at least one volume scale line, and V11 is the volume reading at the maximum scale line of the first measuring tool. For example, the first measuring tool is provided with three volume scale lines, which are 180 ml, 100 ml and 50 ml in a top-down direction, and V11 is 180 ml.

Further, the first measuring tool may be cup-shaped.

### Embodiment III

Embodiment III differs from Embodiment I and Embodiment II in that: as shown in FIG. 16 to FIG. 18, the food steamer 2 does not comprise a side wall 22.

The pot assembly comprises: a second measuring tool configured to quantify the volume of the material to be cooked, and the second measuring tool has a quantitative volume V12; and the inner side wall of the inner pot and the horizontal plane where the bottom wall of the food steamer lies define a first receiving area 4 with the draining-steaming-cooked rice waterline as the upper boundary, the horizontal plane where the bottom wall of the food steamer lies refers to the horizontal plane where the lowest part of the upper surface of the bottom wall of the food steamer lies, the volume of the first receiving area 4 is B2, B2≤(V12×n+100) ml, and n is a coefficient of the second measuring tool of the material to be cooked corresponding to the draining-steaming-cooked rice waterline.

According to B2≤(V12×n+100) ml, it can be satisfied that the material is completely separated from the solution after the completion of the cooking of draining-steaming-cooked rice, which and can ensure the taste of the food on the bottom wall of the food steamer, and the case can be avoided where, if B2>(V12×n+100) ml, the rice on the bottom wall of the food steamer is not completely separated from the water in the cooking chamber after the completion of the cooking of draining-steaming-cooked rice, so that the taste of the draining-steaming-cooked rice is affected.

That n is a coefficient of the second measuring tool of the material to be cooked corresponding to the draining-steaming-cooked rice waterline means that the material to be cooked needs to be contained inn second measuring tools, for example, the draining-steaming-cooked rice waterline h is marked with 3, then n=3, i.e., taking 3 full-capacity measurements using the second measuring tool, and 3 second measuring tools (the second measuring tool is the second measuring tool associated with the pot assembly) of material need to be added onto the bottom wall 21 of the food steamer 2, and after the addition of rice, water is added to the cooking chamber 18 to reach the draining-steaming-cooked rice waterline h. In another example, the draining-steaming-cooked rice waterline h is marked with 0.5, then n=0.5, and ½ second measuring tool of material needs to be added onto the bottom wall of the food steamer. Thus, n is greater than 0, and may be an integer or a fraction.

It can be understood that the coefficient of the second measuring tool of the material to be cooked corresponding to the draining-steaming-cooked rice waterline can be directly provided in the vicinity of the waterline 28, for example, the draining-steaming-cooked rice waterline h is marked with 3, 3 is the coefficient of the second measuring tool of the material to be cooked, and the coefficient of the second measuring tool of the material to be cooked can also be written in the instructions attached to the product, or obtained by a user by scanning a code or from the Internet.

The second measuring tool is provided with at least one volume scale line, and V12 is the volume reading at the maximum scale line of the second measuring tool. For example, the second measuring tool is provided with three volume scale lines, which are 180 ml, 100 ml and 50 ml in a top-down direction, and V12 is 180 ml.

Further, the second measuring tool may be cup-shaped.

The draining-steaming-cooked rice waterline 28 satisfies:

0<C/D≤1.4, and C is the weight of the solution in the first receiving area 4 corresponding to the information of solution indicated by the draining-steaming-cooked rice waterline 28, and D is the weight of the material to be cooked in the first receiving area 4 corresponding to the information of material to be cooked indicated by the draining-steaming-cooked rice waterline 28.

C refers to the weight of the water on the upper side of the plane where the bottom wall of the food steamer lies, between the plane where the draining-steaming-cooked rice waterline lies and the plane corresponding to the bottom wall of the food steamer, in the state where rice having an average moisture content of less than 17% corresponding to the draining-steaming-cooked rice waterline is placed on the food steamer, C including the weight of water in the gaps among the rice grains.

In a specific embodiment, for a food steamer 2 without a side wall 22, the handle 24 is connected to the bottom wall 21 of the food steamer 2. The bottom wall 21 of the food steamer 2 protrudes upwardly to form a plurality of handles 24, for example, to form two handles 24, the two handles 24 being provided at two opposite end portions of the bottom wall 21 of the food steamer 2. The handle 24 may be solid, or each handle 24 may be in the form of a handle ring.

In another specific embodiment, the handle 24 may cross the food steamer 2 at the middle, one end of the handle 24 is connected to one end portion of the bottom wall 21 of the food steamer 2, and the other end of the handle 24 is connected to the other end portion of the bottom wall 21 of the food steamer 2, and in order to reduce the volume of the food steamer 2, in this case, the handle 24 is rotatably connected to the food steamer 2.

In order to realize the positioning of the food steamer in the inner pot, the inner pot 1 is provided with a first positioning structure.

After the food steamer 2 is placed in the inner pot 1, the food steamer 2 cooperates with the first positioning structure to achieve stable placement of the food steamer 2 in the inner pot 1.

### Example 1: The first positioning structure comprises a third step 14 provided on the side wall 12 of the inner pot 1, and the bottom wall 21 of the food steamer 2 is supported on the third step 14. The third step has a ring shape provided in the circumferential direction of the inner pot, or there are a plurality of third steps, the plurality of third steps are uniformly arranged on the side wall of the inner pot, and the plurality of third steps may be at the same height.

Example 2: The first positioning structure comprises a first positioning protrusion provided on the inner wall surface of the side wall 12 of the inner pot 1, and the bottom wall 21 of the food steamer 2 is supported on the first positioning protrusion. The inner wall surface of the side wall of the inner pot protrudes inwardly to form the first positioning protrusion, and it is also possible that the inner wall surface of the side wall of the inner pot protrudes inwardly and circumferentially to form a ring-shaped first positioning protrusion, or there are a plurality of first positioning protrusions which are uniformly distributed on the side wall of the inner pot, and the plurality of first positioning protrusions may be at the same height.

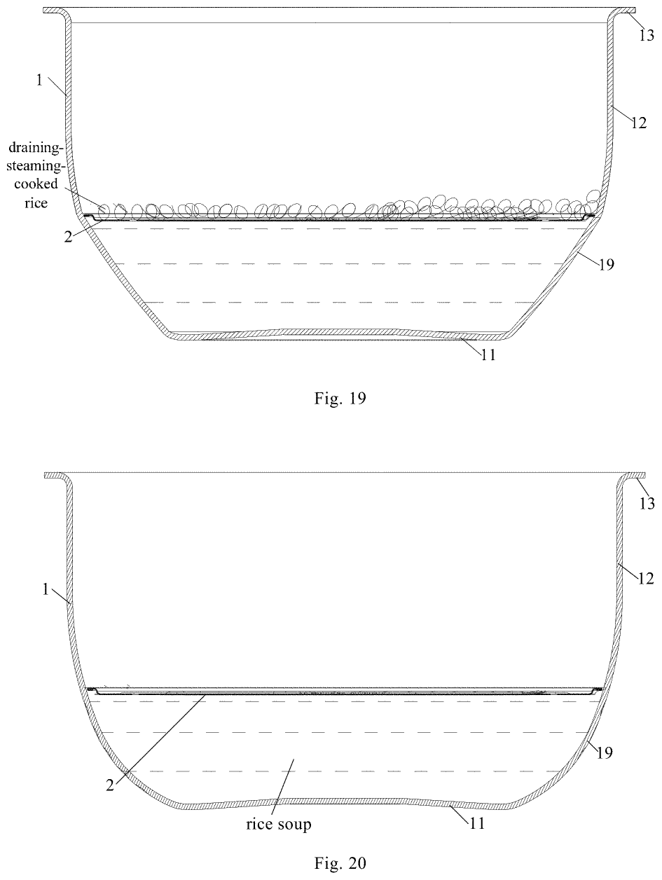

Example 3: The first positioning structure comprises a first transition section 19 connected between the side wall 12 of the inner pot 1 and the bottom wall 11 of the inner pot 1, the cross-sectional area of the first transition section 19 is smaller than the cross-sectional area of the side wall 12 of the inner pot 1 connected to the first transition section 19, and the food steamer 2 is supported on the first transition section 19, or the food steamer 2 is supported at the junction between the first transition section and the side wall of the inner pot. The first transition section may be arc-shaped or rectilinear, as shown in FIG. 19, the first transition section is rectilinear, and the junction of the first transition section and the side wall of the inner pot form a corner at which the food steamer is supported. As shown in FIG. 20, the first transition section has a circular arc shape, and the food steamer is supported on the first transition section.

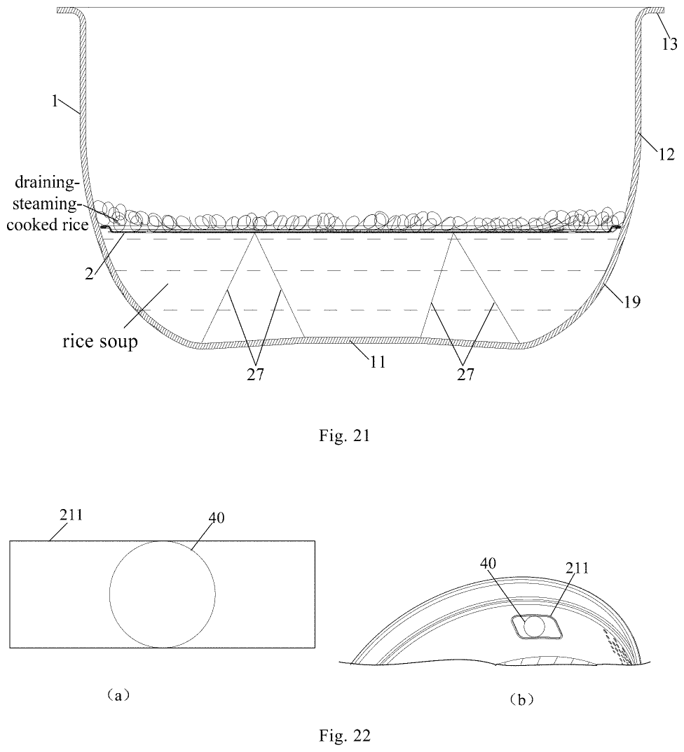

In some embodiments, as shown in FIG. 21, the food steamer 2 is provided with a bracket 27, and the bracket 27 abuts against the inner pot 1.

A bracket 27 is provided on the bottom wall 21 of the food steamer 2, and the bracket 27 abuts against the inner pot 1, for example, against the bottom wall 21 of the inner pot 1. In order to improve the stability of the bracket 27 supporting the food steamer 2, a plurality of brackets 27 are provided, and the plurality of brackets 27 are uniformly disposed in the circumferential direction of the food steamer 2. The brackets 27 may be fixedly connected or detachably connected to the food steamer 2. It will be appreciated that the brackets may also be connected to the inner pot 1, and the brackets may be fixedly connected or detachably connected to the inner pot 1.

The arrangement of the structure of the first positioning structure and the brackets is suitable for the food steamer 2 with a side wall 22 and also suitable for the food steamer 2 without a side wall 22.

In some embodiments, the draining-steaming-cooked rice waterline 28 is provided on the side wall 12 of the inner pot 1. For a food steamer 2 without a side wall 22, the draining-steaming-cooked rice waterline 28 is provided on the side wall 22 of the inner pot 1. It is to be understood that it is also feasible to describe the draining-steaming-cooked rice waterline 28 in the instructions attached to the cooking appliance 100, for example, describing in the instructions that water covers the surface of rice, in this case, the inner pot and the food steamer may not be provided with a draining-steaming-cooked rice waterline, of course, the inner pot and/or the food steamer may also be provided with a draining-steaming-cooked rice waterline. In one embodiment, a water gauge is sold together with the cooking appliance 100, the water gauge is provided with draining-steaming-cooked rice waterline 28, when cooking, the user places the water gauge in the inner pot 1, and in this case, the water gauge is used in the same manner as the draining-steaming-cooked rice waterline 28 printed on the side wall 22 of the inner pot 1.

### Embodiment IV

On the basis of Embodiment I, Embodiment II or Embodiment III, the pot assembly comprises: a steamer pot placed in the inner pot 1 and located above the bottom wall 21 of the food steamer 2.

The steamer pot comprises a bottom wall, and the bottom wall of the steamer pot may be provided with through holes penetrating the bottom wall of the steamer pot, or may not be provided with through holes penetrating the bottom wall of the steamer pot. The steamer pot may further comprise a side wall, the side wall of the steamer pot has a ring shape and is connected above the bottom wall of the steamer pot, and the side wall of the steamer pot may be provided with through holes penetrating the side wall of the steamer pot, or may not be provided with through holes penetrating the side wall of the steamer pot. When neither of the bottom wall and the side wall of the steamer pot is provided with through holes, the steamer pot can be used for cooking rice or cooking porridge, and realizing both the cooking of draining-steaming-cooked rice and the cooking of rice or both the cooking of draining-steaming-cooked rice and the cooking of porridge. It will be appreciated that the food steamer 2 is taken out from the inner pot 1, the steamer pot may be used with the inner pot 1. When it is necessary to use the steamer pot, the steamer pot is placed above the food steamer 2, and when it is not necessary to use the steamer pot, the steamer pot is taken out of the inner pot 1.

The steamer pot may be supported on the inner pot or on the food steamer.

### Embodiment V

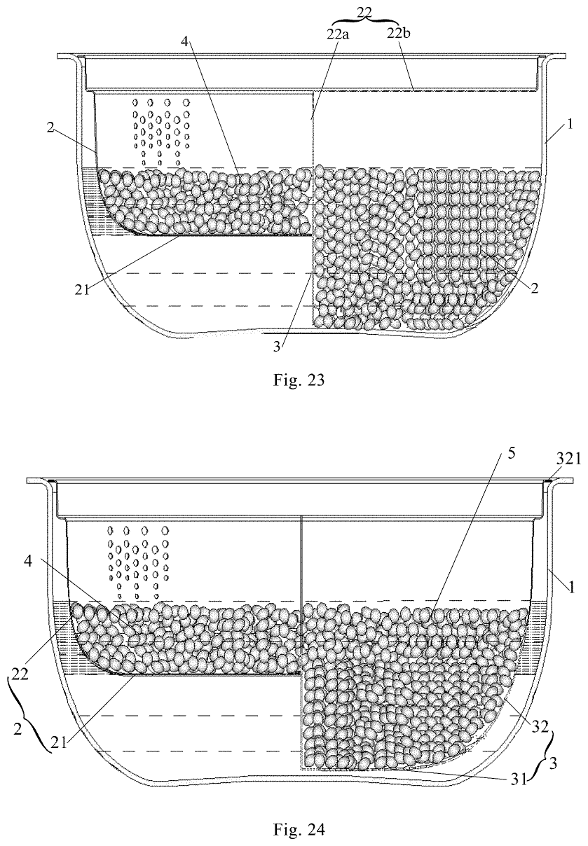

As shown in FIG. 23, on the basis of Embodiment I, Embodiment II, Embodiment III or Embodiment IV, the pot assembly comprises: a partition 3 located in the cooking chamber, the partition 3, and the food steamer 2 jointly partitions the cooking chamber into a plurality of receiving areas, the plurality of receiving areas including the first receiving area 4 and a second receiving area 5.

The partition 3 is disposed on the inner pot 1, and further, the partition 3 is detachably or fixedly connected to the inner pot 1; or the partition 3 is disposed on the food steamer 2, and further, the partition 3 is detachably or fixedly connected to the food steamer 2.

The cooking chamber is partitioned into the first receiving area 4 and the second receiving area 5 by the partition 3 and the food steamer 2. The first receiving area 4 may be used for making draining-steaming-cooked rice, and the user may use the second receiving area 5 according to his own actual needs, for example, cooking rice, cooking porridge, etc. using the second receiving area 5, thus greatly expanding the range of use of the cooking appliance in the present disclosure.

Further, the partition 3, the food steamer 2, and the inner wall surface of the inner pot 1 jointly define the second receiving area 5.

The inner wall surface of the inner pot 1 is part of the second receiving area 5, which can simplify the structure of the partition 3 and reduce the cost of the partition 3.

Further, the food steamer 2 comprises a side wall connected above the bottom wall 21 of the food steamer 2, and the partition 3 is located outside the food steamer 2. For example, the bottom wall 21 of the food steamer 2 may not be circular, the bottom wall 21 of the food steamer 2 is semicircular, the partition 3 is provided at the junction of the bottom wall 21 and the side wall of the food steamer 2, the partition 3 extends downwardly to the bottom of the inner pot 1, and further, the partition 3 abuts against the bottom wall surface of the inner pot 1.

The partition 3 is located outside the food steamer 2 so that the partition 3 does not affect the structure of the food steamer 2.

Further, the partition 3 is located below the bottom wall 21 of the food steamer 2, which further simplifies the structure of the partition 3, and can increase the size of the second receiving area 5.

Further, the partition 3 may be in the form of a plate, and the partition plate 3 may be a flat plate or a curved plate.

Further, the partition 3 is provided with through holes or is not provided with through holes. As shown in FIG. 23, the middle-upper end of the side wall 22 of the food steamer 2 is provided with communication holes.

### Embodiment VI

As shown in FIG. 24 to FIG. 26, Embodiment VI differs from Embodiment V in that: the partition 3 comprises a bottom wall and a side wall connected to the bottom wall 31 of the partition 3 and located above the bottom wall 31 of the partition 3, and the food steamer 2 and the partition 3 jointly define the second receiving area 5.

The bottom wall 31 of the partition 3 is at the same height as or at a different height from the bottom wall 21 of the food steamer 2, as shown in FIG. 26, for example, the bottom wall 31 of the partition 3 is at the same height as the bottom wall 21 of the food steamer 2, and as shown in FIG. 24, the bottom wall 31 of the partition 3 is lower than the bottom wall 21 of the food steamer 2. It can be understood that the bottom wall 31 of the partition 3 may also be higher than the bottom wall 21 of the food steamer 2.

The partition 3 comprises the bottom wall 31 and the side wall 32, and the structure of the partition 3 can be reasonably arranged according to the requirements of shape and size of the second receiving area 5, to construct the second receiving area 5 in any shape, to enrich the use of the cooking appliance.

Further, the side wall 32 of the partition 3 is provided with a second flange 321, and the second flange 321 is supported on the inner pot 1.

An upper end of the side wall 32 of the partition 3 is everted to form the second flange 321, which may be the upper end of the side wall 32 of the partition 3 extending outwardly and circumferentially to form a ring-shaped second flange 321, or the upper end of the side wall 32 of the partition 3 extending outwardly to form a plurality of second flanges 321 spaced apart from each other.

The second flange 321 is supported on the inner pot 1, that is, the partition 3 is hung on the inner pot 1 by the second flange 321, realizing the positioning of the partition 3 in the inner pot 1.

Further, the side wall of the inner pot 1 extends outwardly to form a pot rim, the second flange 321 is supported on the pot rim or at a junction between the pot rim and the side wall of the inner pot 1, and the second flange 321 is lower than the pot rim.

The second flange 321 is lower than the pot rim, and in this way, the second flange 321 does not affect sealing between the sealing ring and the inner pot 1 and will not cause air leakage at the sealing ring.

In the first specific embodiment, the side wall of the inner pot 1 extends outwardly to form a pot rim, the side wall of the inner pot 1 is connected to the pot rim by a second arc or a second non-arc curve, and the second flange 321 is supported at the second arc or at the second non-arc curve.

In the second specific embodiment, the side wall of the inner pot 1 extends outwardly to form a pot rim, the pot rim or the junction between the pot rim and the side wall of the inner pot 1 is recessed to form a fourth step, and the second flange 321 is supported on the fourth step.

In the third specific embodiment, the side wall of the inner pot 1 extends outwardly to form a pot rim, the side wall of the inner pot 1 is connected to the pot rim by a second slope, and the second flange 321 is supported on the second slope.

Further, the inner pot 1 is provided with a second positioning structure, and the partition 3 is positioned with respect to the inner pot 1 by the second positioning structure.

After the partition 3 is placed in the inner pot 1, the partition 3 cooperates with the second positioning structure to achieve stable placement of the partition 3 in the inner pot 1.

Example 1: The second positioning structure comprises a fifth step provided on the side wall of the inner pot 1, and the partition 3 is supported on the fifth step. The fifth step has a ring shape provided in the circumferential direction of the inner pot 1, or there are a plurality of fifth steps, the plurality of fifth steps are uniformly arranged on the side wall of the inner pot 1, and the plurality of fifth steps may be at the same height.

Example 2: The second positioning structure comprises a second positioning protrusion provided on the inner wall surface of the side wall of the inner pot 1, and the partition 3 is supported on the second positioning protrusion. The inner wall surface of the side wall of the inner pot 1 protrudes inwardly to form the second positioning protrusion, and it is also possible that the inner wall surface of the side wall of the inner pot 1 protrudes inwardly and circumferentially to form a ring-shaped second positioning protrusion, or there are a plurality of second positioning protrusions which are uniformly distributed on the side wall of the inner pot 1, and the plurality of second positioning protrusions may be at the same height.

Example 3: The second positioning structure comprises a second transition section connected between the side wall of the inner pot 1 and the bottom wall of the inner pot 1, the cross-sectional area of the second transition section is smaller than the cross-sectional area of the side wall of the inner pot 1 connected to the second transition section, and the partition 3 is supported on the second transition section or at a junction between the second transition section and the side wall of the inner pot 1. The second transition section may be arc-shaped or rectilinear.

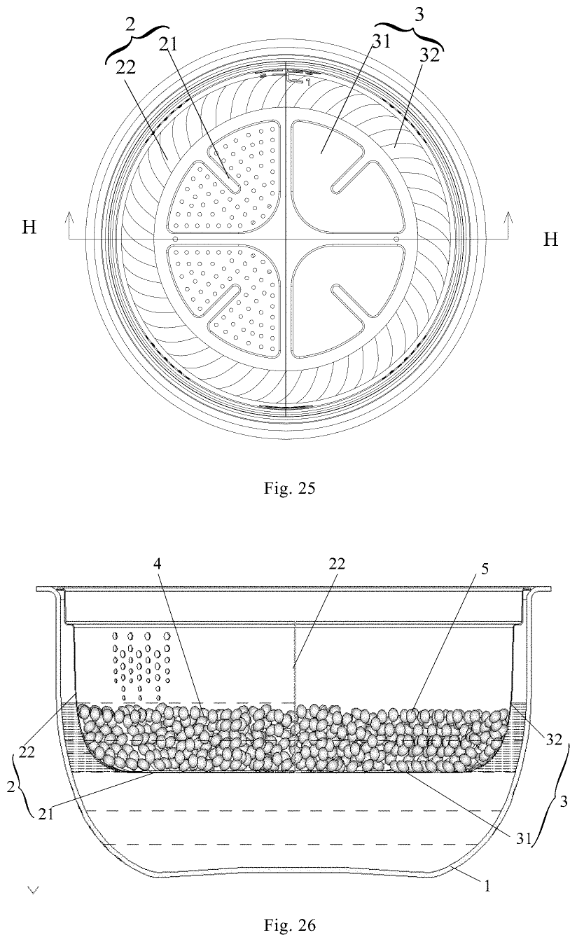

Further, the partition 3 is provided with through holes or is not provided with through holes, as shown in FIG. 24, through holes may be provided on the bottom wall 31 of the partition plate 3, and as shown in FIG. 25, there are no through holes on the partition plate 3.

The partition 3 may or may not be provided with through holes, depending on the use of the second receiving area 5 and the structure of the partition 3.

### Embodiment VII

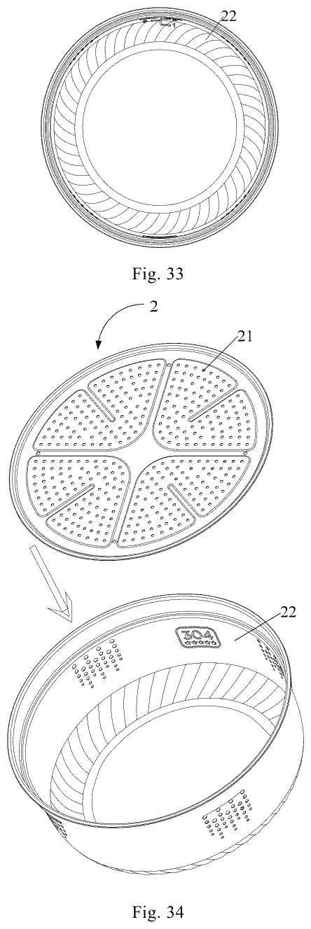

Embodiment VII differs from Embodiment I in that: as shown in FIG. 33 and FIG. 34, the food steamer 2 comprises: a side wall 22, and the side wall 22 of the food steamer 2 is sleeved on the outer side of the bottom wall 21 of the food steamer 2 and is connected to the bottom wall 21 of the food steamer 2, a portion of the side wall 22 above the bottom wall 21 of the food steamer 2 and the bottom wall 21 of the food steamer 2 define a receiving space for receiving the rice for making draining-steaming-cooked rice, in this embodiment, the side wall 22 of the food steamer 2 is partially above the bottom wall 21 of the food steamer 2, and partially below the bottom wall 21 of the food steamer 2, and further, the side wall 22 of the food steamer has a ring shape that extends in the circumferential direction of the bottom wall of the food steamer.

The side wall 22 of the food steamer 2 is provided with first communication holes 221. When heating is performed at the boiling stage, after water mixed with starch boils, the mixture of rice soup and foam generated in the pot fills the gap between the food steamer 2 and the inner pot 1 and enters the food steamer 2 from the first communication holes 221 to completely soak the rice; and when heating is not performed at the boiling stage, the mixture of rice, water and foam flows back to the inner pot 1 through the second communication holes 211. When the side wall 22 of the food steamer 2 is sleeved on the outer side of the bottom wall 21 of the food steamer 2, the first communication holes 221 are at least partially provided on the side wall located above the bottom wall 21 of the food steamer 2.

The side wall 22 of the food steamer 2 and the bottom wall 21 of the food steamer 2 may be a one-piece structure or a split structure.

### Embodiment VIII

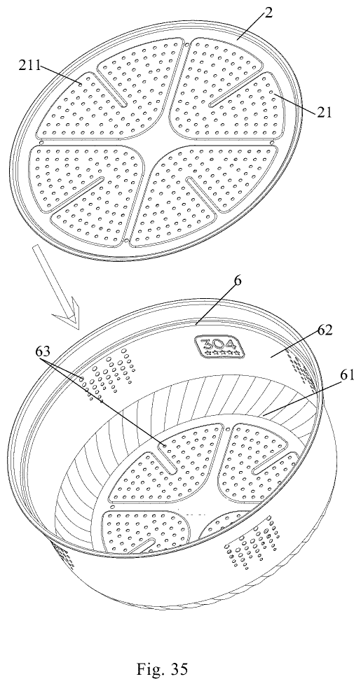

On the basis of Embodiment I to Embodiment VII, as shown in FIG. 35, the cooking appliance comprises: a steaming grid 6, and the steaming grid 6 is placed in the inner pot 1, the steaming grid 6 comprises a bottom wall 61 and a side enclosing wall 62 connected to the bottom wall 61 of the steaming grid 6, the bottom wall 61 and the side enclosing wall 62 of the steaming grid 6 define a mounting space, the bottom wall 61 and the side enclosing wall 62 of the steaming grid 6 are provided with third communication holes 63 communicating the mounting space with the cooking chamber, and the food steamer 2 is located in the mounting space.

The side enclosing wall 62 of the steaming grid 6 may be sleeved on the outer side of the bottom wall 61 of the steaming grid 6, and the side enclosing wall 62 is partially located above the bottom wall 61 of the steaming grid 6 and is partially located below the bottom wall 61 of the steaming grid 6. It is also possible that the side enclosing wall 62 of the steaming grid 6 is wholly located above the bottom wall 61 of the steaming grid 6.

When the third communication holes 63 meet the requirement of cooking of draining-steaming-cooked rice, that is, the third communication holes 63 can allow steam to enter the mounting space, and can also prevent rice in the mounting space from leaking into the inner pot 1, draining-steaming-cooked rice can be cooked in the steaming grid 6, that is, rice used for making draining-steaming-cooked rice is placed on the bottom wall 61 of the steaming grid 6, and in such a case, the food steamer 2 can be used for other purposes, e.g., making steamed buns and the like.

The size of the third communication hole 63 is not limited, and the use of the steaming grid 6 and the food steamer 2 can be reasonably arranged according to the size of the third communication hole 63. For example, when the diameter of the third communication hole 63 is larger than 8 mm, the steaming grid 6 can be used alone for making steamed buns and the like, that is, the existing steaming grid may be used as an alternative for the steaming grid 6, and the existing steaming function and the function of making draining-steaming-cooked rice in the present disclosure can be realized only by adding the food steamer 2 on the basis of the existing steaming grid.

An embodiment of the second aspect of the present disclosure provides a cooking appliance 100, comprising: a pot body 20; and the pot assembly according to any of the embodiments of the first aspect, the pot assembly being placed in the pot body 20.

The cooking appliance 100 provided by the embodiment of the second aspect of the present disclosure comprises the pot assembly according to any of the embodiments of the first aspect, and therefore has all the advantageous effects of the pot assembly according to any of the embodiments, which will not be further described here.

The cooking appliance 100 may be an electric cooker, a pressure cooker, or the like.

The cooking appliance 100 in the present disclosure can realize the function of cooking draining-steaming-cooked rice, as the food steamer 2 is placed in the inner pot 1, and can realize normal cooking, e.g., cooking rice or cooking porridge, when the food steamer 2 is taken out of the inner pot 1.

In the description of the present disclosure, the term “a plurality of” means two or more, unless otherwise explicitly specified or defined; and the terms “connection”, “fixing” and the like should be understood in a broad sense, unless otherwise specified or defined, for example, “connection” may be a fixed connection, and may also be a removable connection, or an integral connection, or electrical connection; and may be direct connection and may also be indirect connection through an intermediary.

In the description of the present specification, it should be understood that the orientation or position relationships indicated by the terms “upper”, “lower”, “front”, “back”, “left”, “right” and the like are the orientation or position relationships based on what is shown in the drawings, are merely for the convenience of describing the present disclosure and simplifying the description, and do not indicate or imply that the device or unit referred to must have a particular direction and is constructed and operated in a specific orientation, and thus cannot be understood as the limitation of the present disclosure.

In the description of the present specification, the descriptions of the terms “one embodiment”, “some embodiments” and “specific embodiments” and the like mean that specific features, structures, materials or characteristics described in conjunction with the embodiment(s) or example(s) are included in at least one embodiment or example of the present disclosure. In the specification, the schematic representation of the above terms does not necessarily refer to the same embodiment or example. Moreover, the particular features, structures, materials or characteristics described may be combined in a suitable manner in any one or more embodiments or examples.

1. A pot assembly, comprising:
an inner pot, defining a cooking chamber; and
a food steamer, configured to be adapted to be placed in the cooking chamber, the food steamer being provided with communication holes communicating with the cooking chamber, the food steamer comprising a bottom wall,
one or more of the inner pot and the food steamer being provided with a draining-steaming-cooked rice waterline, the food steamer being placed in the cooking chamber, and the draining-steaming-cooked rice waterline being higher than the bottom wall of the food steamer.

2. The pot assembly according to claim 1, wherein
the food steamer comprises a side wall connected to the bottom wall of the food steamer, an inner side wall of the inner pot, a horizontal plane where the bottom wall of the food steamer lies and a horizontal plane where the draining-steaming-cooked rice waterline lies define a first receiving area, a volume of the first receiving area is V1, and in the first receiving area, a volume of the food steamer is B, then 0<(V1−B)/B≤1; and
wherein the draining-steaming-cooked rice waterline satisfies:
0<C/D≤1.4, wherein C is the weight of a solution in the first receiving area corresponding to information of solution indicated by the draining-steaming-cooked rice waterline, D is the weight of a material to be cooked corresponding to information of material to be cooked indicated by the draining-steaming-cooked rice waterline, and the bottom wall of the food steamer is adapted to receive the material to be cooked.

3. The pot assembly according to claim 1, wherein
the food steamer comprises a side wall connected to the bottom wall of the food steamer,
the pot assembly comprises a first measuring tool configured to quantify a volume of a material to be cooked, wherein the first measuring tool has a quantitative volume V11,
an inner side wall of the inner pot, a horizontal plane where the bottom wall of the food steamer lies and a horizontal plane where the draining-steaming-cooked rice waterline lies define a first receiving area, in the first receiving area, the volume of the food steamer is B 1, B1≤(V11×n+100) ml, wherein n is a coefficient of the first measuring tool corresponding to the draining-steaming-cooked rice waterline,
wherein a volume of the inner pot between the bottom wall of the food steamer and the bottom wall of the inner pot is V2, then V2≤1000 ml,
wherein the food steamer comprises a side wall connected to the bottom wall of the food steamer, a gap between the side wall of the food steamer and an inner side wall of the inner pot is smaller than or equal to 20 mm.

4. The pot assembly according to claim 1, comprising:
a second measuring tool configured to quantify a volume of material to be cooked, wherein the second measuring tool has a quantitative volume V12,
an inner side wall of the inner pot, a horizontal plane where the bottom wall of the food steamer lies and a horizontal plane where the draining-steaming-cooked rice waterline lies define a first receiving area, the volume of the first receiving area is B2, then B2≤(V12×n+100) ml, wherein n is a coefficient of the second measuring tool corresponding to the draining-steaming-cooked rice waterline.

5. The pot assembly according to claim 1, wherein
the inner pot and the food steamer are provided with a plurality of top-down draining-steaming-cooked rice waterlines, and the draining-steaming-cooked rice waterlines are all higher than the bottom wall of the food steamer; and/or
the inner pot and the food steamer are provided with a plurality of sets of draining-steaming-cooked rice waterlines, wherein each set of draining-steaming-cooked rice waterlines include a plurality of top-down draining-steaming-cooked rice waterlines, the plurality of sets of draining-steaming-cooked rice waterlines correspond to different materials to be cooked, and the plurality of sets of draining-steaming-cooked rice waterlines are provided in a circumferential direction of the inner pot and/or the food steamer.

6. (canceled)

7. The pot assembly according to claim 1, wherein
the draining-steaming-cooked rice waterline is higher than an upper surface of a material to be cooked corresponding to information of material to be cooked indicated by the draining-steaming-cooked rice waterline, wherein the bottom wall of the food steamer is adapted to receive the material to be cooked; and
a volume of the food steamer between the draining-steaming-cooked rice waterline and the bottom wall of the food steamer is greater than a volume of the material to be cooked corresponding to the information of material to be cooked indicated by the draining-steaming-cooked rice waterline, wherein the bottom wall of the food steamer is adapted to receive the material to be cooked.

8-9. (canceled)

10. The pot assembly according to claim 1, wherein
the food steamer comprises a side wall connected to the bottom wall of the food steamer, a rounded corner is provided between the side wall of the food steamer and the bottom wall of the food steamer, and an orthographic projection of the rounded corner on a plane where the bottom wall of the food steamer lies has a length of less than or equal to 50 mm, or the food steamer comprises a side wall connected to the bottom wall of the food steamer, and the side wall of the food steamer is connected to the bottom wall of the food steamer by a connecting slope or by a non-arc curve.

11. The pot assembly according to claim 1, wherein
the food steamer comprises a side wall connected to the bottom wall of the food steamer, the communication holes include first communication holes provided on the side wall of the food steamer, and an area of the first communication hole is smaller than or equal to 20 mm²; and/or
the food steamer comprises a side wall connected to the bottom wall of the food steamer, the communication holes include first communication holes provided on the side wall of the food steamer, and a total area of the first communication holes is greater than the minimum flow area of a steam passage of a cooking appliance; and
the food steamer comprises a side wall connected to the bottom wall of the food steamer, the communication holes include first communication holes provided on the side wall of the food steamer, and a total area of the first communication holes is greater than 10 mm²; and/or
the food steamer comprises a side wall connected to the bottom wall of the food steamer, the communication holes include first communication holes provided on the side wall of the food steamer, and the first communication holes are at least partially higher than the highest draining-steaming-cooked rice waterline.

12. The pot assembly according to claim 1, wherein
the communication holes include second communication holes provided on the bottom wall of the food steamer, and the diameter of the largest circle capable of flatly passing through the second communication hole is in the range of 0.5 mm-2.5 mm, or an area of the second communication hole is in the range of 0.5 mm²-4 mm²; and/or
the communication holes include second communication holes provided on the bottom wall of the food steamer, and a total area of the second communication holes is S1, then S1≥150 mm²; and/or
the communication holes include second communication holes provided on the bottom wall of the food steamer, the total area of the second communication holes is S1, and an area of an orthographic projection of the food steamer on a horizontal plane is S2, then S1/S2≥ 1/100.

13. The pot assembly according to claim 1, wherein
an upper surface of the bottom wall of the food steamer is provided with a flow guide groove, wherein the flow guide groove is provided with flow guide holes penetrating the bottom wall of the food steamer, and the flow guide groove is located at the lowest position of the bottom wall of the food steamer; and
the communication holes include second communication holes provided on the bottom wall of the food steamer, the bottom wall of the food steamer is provided with a plurality of flow guide grooves, the plurality of flow guide grooves are arranged in a radial shape on the bottom wall of the food steamer, the second communication holes are provided between two adjacent flow guide grooves, or the bottom wall of the food steamer is provided with a plurality of flow guide grooves, the flow guide groove having a ring shape, the plurality of flow guide grooves are arranged in a nested manner in sequence, and the second communication holes are provided between two adjacent flow guide grooves.

14. (canceled)

15. The pot assembly according to claim 1, wherein
the food steamer comprises a side wall, the side wall of the food steamer is sleeved on an outer side of the bottom wall of the food steamer and partially below the bottom wall of the food steamer, a portion of the side wall of the food steamer above the bottom wall of the food steamer and the bottom wall of the food steamer define a receiving space, or the food steamer comprises a side wall, the side wall of the food steamer is connected to an edge of the bottom wall of the food steamer and located above the bottom wall of the food steamer; and/or
an upper surface or a lower surface of the bottom wall of the food steamer protrudes upwardly or downwardly to form a reinforcing rib.

16. The pot assembly according to claim 1, wherein
the food steamer comprises a side wall connected to the bottom wall of the food steamer, the side wall of the food steamer is provided with a first step,
the height of the first step from an upper end surface of the food steamer is H1, then 5 mm≤H1≤50 mm; and/or the height of the first step from an upper end surface of the food steamer is H1, the height of the food steamer is H, then 1/9≤H1/H≤¾.

17. The pot assembly according to claim 1, wherein
the food steamer comprises a side wall connected to the bottom wall of the food steamer, and the height of the food steamer is H, then 40 mm≤H≤100 mm.

18. The pot assembly according to claim 1, wherein
the food steamer comprises a side wall connected to the bottom wall of the food steamer, the side wall of the food steamer is provided with a first flange, the side wall of the inner pot extends outwardly to form a pot rim, the first flange is supported on the pot rim or at a junction between the pot rim and the side wall of the inner pot, and the first flange is lower than the pot rim,
wherein the side wall of the inner pot is connected to the pot rim by a first arc, and the first flange is supported at the first arc, or the pot rim is provided with a second step, and the first flange is supported on the second step, or the side wall of the inner pot is connected to the pot rim by a first slope, and the first flange is supported on the first slope.

19. The pot assembly according to claim 1, wherein
the inner pot is provided with a first positioning structure, and the food steamer is positioned with respect to the inner pot by the first positioning structure,
wherein the first positioning structure comprises a third step provided on a side wall of the inner pot, and the bottom wall of the food steamer is supported on the third step, or the first positioning structure comprises a first positioning protrusion provided on an inner side wall of the inner pot, and the bottom wall of the food steamer is supported on the first positioning protrusion, or the first positioning structure comprises a first transition section connected between the side wall of the inner pot and the bottom wall of the inner pot, a cross-sectional area of the first transition section is smaller than a cross-sectional area of the side wall of the inner pot connected to the first transition section, and the food steamer is supported on the first transition section or at a junction between the first transition section and the side wall of the inner pot.

20. The pot assembly according to claim 1, wherein
the food steamer is provided with a bracket, and the bracket abuts against the inner pot.

21. The pot assembly according to claim 1, wherein
the food steamer comprises a side wall connected to the bottom wall of the food steamer, and the draining-steaming-cooked rice waterlines are provided on one or more of the side wall of the inner pot and on the side wall of the food steamer.

22. The pot assembly according to claim 1, wherein
the food steamer is provided with a handle, wherein the handle is fixedly connected with the food steamer, or the handle is rotatably connected with the food steamer; and/or
the pot assembly comprises a steamer pot configured to be adapted to be placed in the inner pot and located above the bottom wall of the food steamer; and/or
the pot assembly comprises a steaming grid, the steaming grid comprises a bottom wall and a side enclosing wall connected to the bottom wall of the steaming grid, the bottom wall and the side enclosing wall of the steaming grid define a mounting space, the food steamer is located in the mounting space, and the bottom wall and the side enclosing wall of the steaming grid are provided with third communication holes.

23. The pot assembly according to claim 1, comprising:
a partition configured to be adapted to be placed in the cooking chamber, the partition and the food steamer jointly partitioning the cooking chamber into a plurality of receiving areas, the plurality of receiving areas including a first receiving area and a second receiving area, wherein the partition, the food steamer, and the inner wall surface of the inner pot jointly define the second receiving area, wherein
the food steamer comprises a side wall connected to the bottom wall of the food steamer, and the partition is located outside the food steamer, and/or
the partition is located below the bottom wall of the food steamer, wherein
the partition comprises a bottom wall and a side wall connected to the bottom wall of the partition and located above the bottom wall of the partition, and the food steamer and the partition jointly define the second receiving area, wherein
the side wall of the partition is provided with a second flange, the side wall of the inner pot extends outwardly to form a pot rim, the second flange is supported on the pot rim or at a junction between the pot rim and the side wall of the inner pot, and the second flange is lower than the pot rim,
wherein the side wall of the inner pot is connected to the pot rim by a second arc, and the second flange is supported at the second arc, or the pot rim is provided with a fourth step, and the second flange is supported on the fourth step, or the side wall of the inner pot is connected to the pot rim by a second slope, and the second flange is supported on the second slope, wherein
the inner pot is provided with a second positioning structure, and the partition is positioned with respect to the inner pot by the second positioning structure,
wherein the second positioning structure comprises a fifth step provided on a side wall of the inner pot, and the partition is supported on the fifth step, or the second positioning structure comprises a second positioning protrusion provided on an inner side wall of the inner pot, and the partition is supported on the second positioning protrusion, or the second positioning structure comprises a second transition section connected between the side wall of the inner pot and the bottom wall of the inner pot, a cross-sectional area of the second transition section is smaller than a cross-sectional area of the side wall of the inner pot connected to the second transition section, and the partition is supported on the second transition section or at a junction between the second transition section and the side wall of the inner pot, wherein the partition is provided with through holes or is not provided with through holes.

24-29. (canceled)

30. A cooking appliance, comprising:
a pot body; and
the pot assembly according to claim 1, the pot assembly being placed in the pot body.
